(19) United States
(12) Patent Application Publication
(10) Pub. No.: US 2026/0279094 A1
(43) Pub. Date: Sep. 17, 2026

(54) METHOD FOR GUIDING BODY REGION TOWARD TARGET POSE

(71) Applicant: Tencent Technology (Shenzhen) Company Limited, Shenzhen (CN)

(72) Inventor: Weipeng YAO, Shenzhen (CN)

(73) Assignee: Tencent Technology (Shenzhen) Company Limited, Shenzhen, GD (CN)

(21) Appl. No.: 19/670,866

(22) Filed: May 7, 2026

Related U.S. Application Data
(63) Continuation of application No. PCT/CN2024/136013, filed on Dec. 2, 2024.

(30) Foreign Application Priority Data
Jan. 2, 2024 (CN) 202410015511.4

(51) Int. Cl. G06V 40/10; G06F 3/01; G06F 3/04815; G06T 7/11; G06T 7/246; G06T 7/564; G06T 7/73; G06V 10/25; G06V 10/44

(52) U.S. Cl. CPC G06V 40/11; G06F 3/011; G06F 3/04815; G06T 7/11; G06T 7/246; G06T 7/564; G06T 7/73; G06V 10/25; G06V 10/44; G06T 2207/10016

(57) ABSTRACT

In a method for guiding a body region toward a target pose, a camera preview screen and an acquisition box are displayed. In the method, whether the body region is recognized in image frames in the camera preview screen is determined. In the method, based on the body region being recognized, a tracking box is displayed in the camera preview screen, a shape of the tracking box changing with an angle between a first reference plane where the body region is located and a second reference plane corresponding to the acquisition box in a real space. In the method, it is determined that the body region reaches the target pose when the tracking box and the acquisition box satisfy a matching condition. Apparatus and non-transitory computer-readable storage medium counterparts are also contemplated.

### RELATED APPLICATIONS

The present application is a continuation of International Application No. PCT/CN2024/136013, filed on Dec. 2, 2024, which claims the priority to Chinese Patent Application No. 202410015511.4, filed on Jan. 2, 2024, and entitled “METHOD AND APPARATUS FOR ACQUIRING IDENTITY FEATURE, DEVICE, AND STORAGE MEDIUM.” The entire disclosures of the prior applications are hereby incorporated by reference.

### FIELD OF THE TECHNOLOGY

This disclosure relates to the technical field of human-computer interaction, including methods and apparatuses for determining an acquisition pose, devices, and storage media.

### BACKGROUND OF THE DISCLOSURE

In related technologies, on account of stability, uniqueness, and convenience of biometric features, the security and convenience of identity recognition can be improved when unique biometric features of each user are used for the identity recognition. In some examples, related biometric features include faces, irises, fingerprints, palm prints, etc.

For the technology of identity recognition by using the palm print feature, a palm print acquisition device is used to acquire palm print features of the users. However, when acquiring the palm prints by using the palm print acquisition device, the users may adjust the positions of the palms blindly, resulting in increased time for adjustment during palm print acquisition.

### SUMMARY

Embodiments of this disclosure provide methods and apparatuses for determining an acquisition pose, devices, and storage media. One or more technical solutions are summarized below as non-limiting examples.

According to an aspect of this disclosure, a method for guiding a body region toward a target pose is provided. In the method, a camera preview screen configured to display image frames of a camera and an acquisition box in a first display state in the camera preview screen are displayed on a display. In the method, whether the body region that corresponds to a body feature is recognized in the image frames is determined. In the method, based on the body region being recognized in the image frames, a tracking box corresponding to the body region is displayed in the camera preview screen, a shape of the tracking box changing with an angle between a first reference plane where the body region is located and a second reference plane corresponding to the acquisition box in a real space. In the method, a determination is made by processing circuitry that the body region reaches the target pose in the real space when the tracking box and the acquisition box in the first display state satisfy a matching condition. In the method, acquisition pose notification information is displayed on the display when the body region is determined to reach the target pose in the real space.

According to an aspect of this disclosure, an apparatus for guiding a body region toward a target pose is provided. The apparatus includes processing circuitry configured to display, on a display, a camera preview screen configured to display image frames of a camera and an acquisition box in a first display state in the camera preview screen. The processing circuitry is configured to determine whether the body region that corresponds to a body feature is recognized in the image frames. The apparatus includes processing circuitry configured to display, based on the body region being recognized in the image frames, a tracking box corresponding to the body region in the camera preview screen, a shape of the tracking box changing with an angle between a first reference plane where the body region is located and a second reference plane corresponding to the acquisition box in a real space. The apparatus includes processing circuitry configured to determine, by processing circuitry, that the body region reaches the target pose in the real space when the tracking box and the acquisition box in the first display state satisfy a matching condition. The apparatus includes processing circuitry configured to display, on the display, acquisition pose notification information when the body region is determined to reach the target pose in the real space.

According to an aspect of this disclosure, a non-transitory computer-readable storage medium is provided. The non-transitory computer-readable storage medium stores instructions, which when executed by a processor, cause the processor to perform a method for guiding a body region toward a target pose. In the method, a camera preview screen configured to display image frames of a camera and an acquisition box in a first display state in the camera preview screen are displayed on a display. In the method, whether the body region that corresponds to a body feature is recognized in the image frames is determined. In the method, based on the body region being recognized in the image frames, a tracking box corresponding to the body region is displayed in the camera preview screen, a shape of the tracking box changing with an angle between a first reference plane where the body region is located and a second reference plane corresponding to the acquisition box in a real space. In the method, a determination is made that the body region reaches the target pose in the real space when the tracking box and the acquisition box in the first display state satisfy a matching condition. In the method, acquisition pose notification information is displayed on the display when the body region is determined to reach the target pose in the real space.

According to an aspect of this disclosure, a method for determining an acquisition pose is provided. The method includes: displaying a camera preview screen and an acquisition box in a first display state in a process of identity feature acquisition; displaying, in response to determining that a body feature region is recognized in the camera preview screen, a tracking box on a screen region corresponding to the body feature region, the tracking box changing following a change in a pose of the body feature region in a real space; and determining that the pose of the body feature region in the real space reaches the acquisition pose in response to determining that the tracking box and the acquisition box in the first display state satisfy a matching condition.

In an example, the determining that the pose of the body feature region in the real space reaches the acquisition pose includes: switching, on the camera preview screen in response to determining that the tracking box and the acquisition box in the first display state satisfy the matching condition, the acquisition box in the first display state to an acquisition box in a second display state to be displayed, the acquisition box in the second display state being configured to indicate that the pose of the body feature region in the real space reaches the acquisition pose, the first display state being different from the second display state.

In another example, the determining that the pose of the body feature region in the real space reaches the acquisition pose includes: displaying a first notification text on the camera preview screen, the first notification text being configured to indicate that the pose of the body feature region in the real space reaches the acquisition pose.

In an example, after it is determined that the pose of the body feature region in the real space reaches the acquisition pose, the camera preview screen is uploaded to a server. In a case that the server fails to retrieve the camera preview screen from an identity feature library, the server stores the camera preview screen into the identity feature library. The server transmits a notification message that enrollment is done to a terminal, and the terminal displays a notification message that enrollment is done successfully on an interface of the terminal after receiving the notification message that enrollment is done. The notification message is configured to indicate that a user successfully enrolls an identity feature.

In some embodiments, in a case that the server retrieves the camera preview screen from an identity feature library, the server transmits a notification message of re-enrollment to a terminal, and the terminal displays a notification message of re-enrollment on an interface of the terminal after receiving the notification message of re-enrollment. The notification message is configured to indicate that a user does not need to re-enroll an identity feature.

According to an aspect of this disclosure, an apparatus for determining an acquisition pose is provided. The apparatus includes: a display module configured to display a camera preview screen and an acquisition box in a first display state in a process of identity feature acquisition; the display module being further configured to display, in response to determining that a body feature region is recognized in the camera preview screen, a tracking box on a screen region corresponding to the body feature region, the tracking box changing following a change in a pose of the body feature region in a real space; and a determining module configured to determine that the pose of the body feature region in the real space reaches the acquisition pose in response to determining that the tracking box and the acquisition box in the first display state satisfy a matching condition.

According to an aspect of this disclosure, a computer device is provided. The computer device includes a memory (e.g., including a non-transitory computer-readable storage medium) and processing circuitry (e.g., a processor), the memory having at least one program stored therein, the at least one program being loaded and executed by the processor, to implement the method for determining an acquisition pose described above.

According to an aspect of this disclosure, a non-transitory computer-readable storage medium is provided. The non-transitory computer-readable storage medium has at least one program stored therein, the at least one program being configured for being executed by processing circuitry (e.g., a processor), to implement the method for determining an acquisition pose described above.

According to an aspect of this disclosure, a computer program product or a computer program is provided. The computer program product or the computer program includes at least one program, the at least one program being stored in a non-transitory computer-readable storage medium, and the at least one program being read and executed by processing circuitry (e.g., a processor) from the non-transitory computer-readable storage medium, to implement the method for determining an acquisition pose described above.

The technical solution according to the embodiments of this disclosure has the following effects.

Since the tracking box changes with the change in the pose of the body feature region in the real space, the user can be guided to adjust the pose of the body feature region in the real space by guiding the user to adjust the tracking box. Further, by guiding the user to adjust the tracking box to satisfy the matching condition with the acquisition box in the first display state, the user can adjust the body feature region based on the visualized guidance information, and efficiency of identity feature acquisition by the user can be improved.

### BRIEF DESCRIPTION OF THE DRAWINGS

FIG. 1 shows a structural block diagram of a computer system according to an embodiment of this disclosure.

FIG. 2 shows an interface diagram of a method for determining an acquisition pose according to an embodiment of this disclosure.

FIG. 3 shows a schematic diagram of classifying different terminal devices according to an embodiment of this disclosure.

FIG. 4 shows a flowchart of a method for determining an acquisition pose according to an embodiment of this disclosure.

FIG. 5 shows another interface diagram of a method for determining an acquisition pose according to an embodiment of this disclosure.

FIG. 6 shows yet another interface diagram of a method for determining an acquisition pose according to an embodiment of this disclosure.

FIG. 7 shows yet another interface diagram of a method for determining an acquisition pose according to an embodiment of this disclosure.

FIG. 8 shows yet another interface diagram of a method for determining an acquisition pose according to an embodiment of this disclosure.

FIG. 9 shows another flowchart of a method for determining an acquisition pose according to an embodiment of this disclosure.

FIG. 10 shows yet another flowchart of a method for determining an acquisition pose according to an embodiment of this disclosure.

FIG. 11 shows yet another flowchart of a method for determining an acquisition pose according to an embodiment of this disclosure.

FIG. 12 shows yet another interface diagram of a method for determining an acquisition pose according to an embodiment of this disclosure.

FIG. 13 shows yet another flowchart of a method for determining an acquisition pose according to an embodiment of this disclosure.

FIG. 14 shows yet another interface diagram of a method for determining an acquisition pose according to an embodiment of this disclosure.

FIG. 15 shows yet another flowchart of a method for determining an acquisition pose according to an embodiment of this disclosure.

FIG. 16 shows yet another interface diagram of a method for determining an acquisition pose according to an embodiment of this disclosure.

FIG. 17 shows still another flowchart of a method for determining an acquisition pose according to an embodiment of this disclosure.

FIG. 18 shows yet another interface diagram of a method for determining an acquisition pose according to an embodiment of this disclosure.

FIG. 19 shows yet another interface diagram of a method for determining an acquisition pose according to an embodiment of this disclosure.

FIG. 20 shows still another interface diagram of a method for determining an acquisition pose according to an embodiment of this disclosure.

FIG. 21 shows a structural block diagram of an apparatus for determining an acquisition pose according to an embodiment of this disclosure.

FIG. 22 shows a structural block diagram of a computer device according to an embodiment of this disclosure.

### DETAILED DESCRIPTION

Descriptions of terms in this disclosure are provided as examples only and are not intended to limit the scope of the disclosure.

As used in this disclosure, the phrase “at least one of A, B, or C” is intended to include any one of the recited elements alone or any combination of two or more of the recited elements. For example, “at least one of A, B, or C” includes A alone, B alone, C alone, A and B together, A and C together, B and C together, or A, B, and C together. Similarly, the phrase “one of A or B” includes A, B, or both A and B.

Examples of terms involved in the aspects of the disclosure are briefly introduced.

An acquisition box in a first display state may correspond to a calibration box in a matching process, and the acquisition box in the first display state is configured to match with a tracking box. The acquisition box in the first display state is configured to guide a user to adjust the tracking box (and hence the target object or the body region to be detected) until the tracking box and the acquisition box in the first display state satisfy a matching condition.

The tracking box may correspond to a dynamic box in a matching process. The tracking box changes with a change in a pose of a body region corresponding to a body feature (or also described as a body feature region in this disclosure) in a real space. The body feature region refers to a region on a human body that carries human features, such as a palm region, a fingertip region, and a face region. When the pose of the body feature region in the real space changes, the pose of the body feature region acquired by a camera on a terminal changes, and the tracking box displayed on a camera preview screen on an interface of the terminal also changes accordingly.

An acquisition box in a second display state may correspond to a result box in a matching process. If the acquisition box in the first display state and the tracking box satisfy the matching condition, the acquisition box in the first display state is switched to the acquisition box in the second display state to be displayed. The first display state and the second display state are different display states.

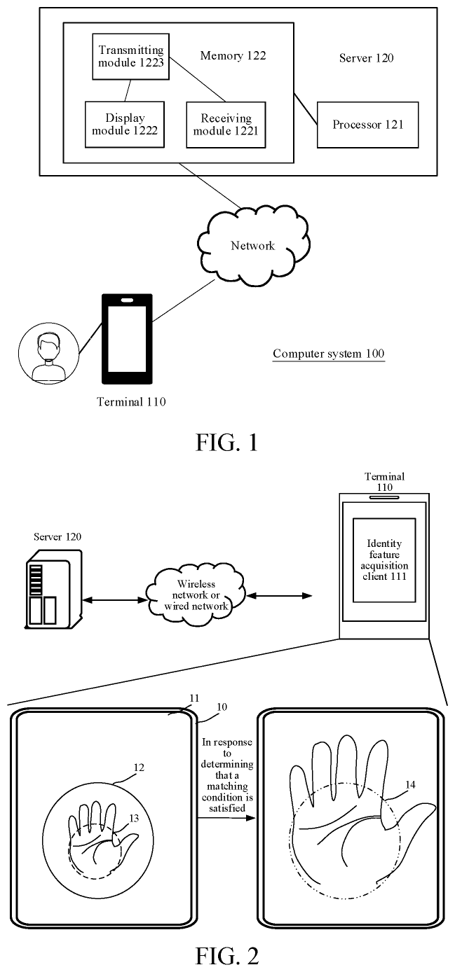

FIG. 1 shows a structural block diagram of a computer system 100 according to an aspect of this disclosure. The computer system 100 includes a terminal 110 and a server 120.

A program or web page supporting acquisition of an identity feature is installed and run on the terminal 110. In some embodiments, the program supporting the identity feature acquisition includes at least one of a game application, a virtual social application, an interactive entertainment application, or a metaverse application. In some embodiments, the program supporting the identity feature acquisition is an application or applet developed for a function of the identity feature acquisition and merely configured to perform the identity feature acquisition. In some embodiments, the program supporting the identity feature acquisition is an application or an applet having the function of the identity feature acquisition. In an aspect of this disclosure, description is made by taking the program supporting the identity feature acquisition being the application developed for the function of the identity feature acquisition and merely configured to perform the identity feature acquisition as an example.

The terminal 110 is a terminal used by a target user, and the target user uses the terminal 110 to acquire the identity feature. For example, as shown in FIG. 2, an identity feature acquisition client 111 supporting the identity feature acquisition being installed and run on the terminal 110 is taken an example. The target user clicks or long presses and opens the identity feature acquisition client 111, to start the identity feature acquisition. In response to a trigger operation, the identity feature acquisition client 111 displays an identity feature acquisition interface 10. On the identity feature acquisition interface 10, a camera preview screen 11 and an acquisition box 12 in a first display state are displayed.

The camera preview screen 11 is a screen shot in real time by the camera of the terminal 110. In some embodiments, the camera preview screen 11 is displayed in full screen on the identity feature acquisition interface 10. In some examples, a display size of the camera preview screen 11 is determined based on a display size of the identity feature acquisition interface 10. For example, when the display size of the identity feature acquisition interface 10 is equal to a screen size of the terminal 110, the camera preview screen 11 is displayed in full screen on the terminal 110. In some embodiments, the camera preview screen 11 is displayed at a target position in the identity feature acquisition interface 10. For example, the camera preview screen 11 is displayed in the acquisition box 12 in the first display state.

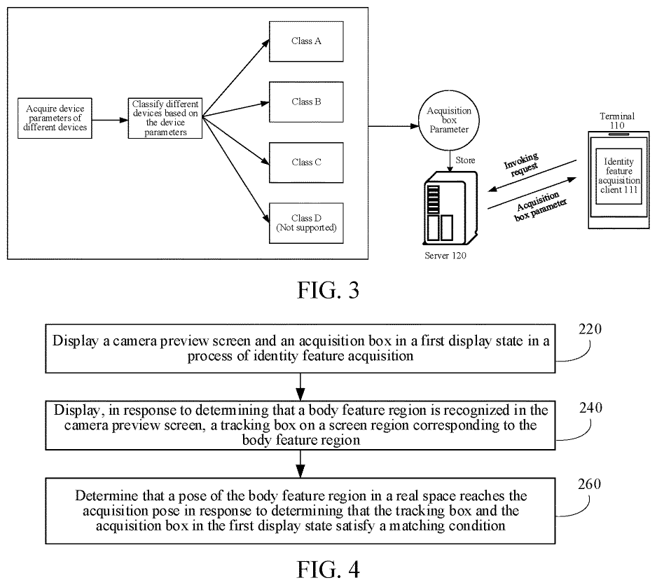

The acquisition box 12 in the first display state is determined based on device parameters of the terminal 110 related to the identity feature acquisition. For example, the device parameters include camera parameters and picture imaging parameters. The camera parameters include at least one of resolution, a focal length, a field of view, distortion, chromatic aberration, or sharpness. The picture imaging parameters are determined based on pictures actually shot by the terminal 110. In some embodiments, as shown in FIG. 3, the device parameters of different devices are acquired in advance, and then different devices are classified based on the device parameters, such as class A, class B, class C, and class D. Each class corresponds to acquisition box parameters, and the acquisition box parameters include at least one of a display size, a display position, or a display form that are configured to indicate that the acquisition box is displayed on an identity feature enrollment interface. The acquisition box parameters are stored in the server 120. In some embodiments, when starting the identity feature acquisition, the terminal 110 transmits a request to invoke the acquisition box parameters to the server 120. The server 120 transmits corresponding acquisition box parameters to the terminal 110 according to a class to which the terminal 110 belongs. The terminal 110 displays the acquisition box 12 in the first display state on the identity feature acquisition interface 10 based on the acquisition box parameters received.

In some embodiments, in response to determining that a body feature region is recognized in the camera preview screen 11, the tracking box 13 is displayed on a screen region corresponding to the body feature region. The tracking box 13 changes with a change in a pose of the body feature region in a real space. The tracking box 13 is configured to guide the user to adjust a display form of the tracking box, to make the tracking box 13 and the acquisition box 12 in the first display state satisfy a matching condition. In a case that the tracking box 13 and the acquisition box 12 in the first display state satisfy the matching condition, the acquisition box 12 in the first display state is switched to an acquisition box 14 in a second display state, to indicate that the pose of the body feature region of the target user in the real space reaches the acquisition pose.

The terminal 110 is connected to the server 120 through a wireless network or a wired network.

The server 120 includes at least one of a server, a plurality of servers, a cloud computing platform, or a virtualization center. For example, the server 120 includes a processor 121 and a memory 122, and the memory 122 further includes a receiving module 1221, a display module 1222, and a transmitting module 1223. The receiving module 1221 is configured to receive the request transmitted by the terminal 110. The display module 1222 is configured to display a program page supporting the identity feature acquisition. The transmitting module 1223 is configured to transmit a response to the terminal 110. The server 120 is configured to provide a background service for the program or the web page supporting the identity feature acquisition. In some embodiments, the server 120 undertakes primary computing work, and the terminal 110 undertakes secondary computing work. Alternatively, the server 120 undertakes secondary computing work, and the terminal 110 undertakes primary computing work. Alternatively, the server 120 and the terminal 110 undertake computing work in a cooperative manner.

In some embodiments, device types of the terminal 110 include at least one of a smartphone, a smart watch, an in-vehicle terminal, a wearable device, a smart television, a tablet computer, an e-book reader, a moving picture experts group audio layer III (MP3) player, a moving picture experts group audio layer IV (MP4) player, a laptop computer, or a desktop computer. The following embodiments will be described with the terminal 110 including the smartphone as an example.

Those of ordinary skill in the art may know that more or less terminals 110 may be provided. For example, only one terminal 110 may be provided, or dozens or hundreds of terminals 110, or more terminals may be provided. The embodiments of this disclosure do not limit a number and the device types of the terminals 110.

The embodiments of this disclosure provide the method for determining an acquisition pose. The user can be guided through the dynamically changing tracking box, which may reduce instances of blind adjustment and improve efficiency of the identity feature acquisition by the user.

FIG. 4 shows a flowchart of a method for determining an acquisition pose according to an embodiment of this disclosure. In some aspects, the method in FIG. 4 includes operations for guiding a body region toward a target pose. The method being performed by the terminal 110 shown in FIG. 1 is taken as an example. The method includes the following operations:

Operation 220: Display a camera preview screen and an acquisition box in a first display state in a process of identity feature acquisition. For example, a camera preview screen configured to display image frames of a camera is displayed on a display, and an acquisition box in a first display state is displayed in the camera preview screen on the display.

In some embodiments, the camera preview screen and the acquisition box in the first display state are displayed in response to a trigger operation on an identity feature acquisition client. The trigger operation includes at least one of single click, double click, left-right slide, up-down slide, long press, hover, face recognition, or voice recognition. The trigger operation includes, but is not limited to, the types described above. Those of ordinary skill in the art are to be able to know that any operation that can implement the functions described above falls within the scope of this disclosure.

In some embodiments, the camera preview screen and the acquisition box in the first display state are displayed simultaneously. In some embodiments, the camera preview screen and the acquisition box in the first display state are not displayed simultaneously. In some embodiments, the acquisition box in the first display state is displayed after the camera preview screen is displayed. For example, the camera preview screen is displayed at first, and then the acquisition box in the first display state is displayed after a detected object is recognized. In some embodiments, the camera preview screen is displayed after the acquisition box in the first display state is displayed.

In some embodiments, the camera preview screen is a screen shot by a camera in real time. In some embodiments, the camera preview screen is displayed in full screen on a terminal screen. In some embodiments, the camera preview screen is displayed in a target region on the terminal screen. The target region is preset or the target region is dynamically changed. For example, the target region is a one-third region in a middle of the terminal screen. In an aspect of this disclosure, description is made by taking the camera preview screen being displayed in full screen on the terminal screen as an example.

In some embodiments, the acquisition box in the first display state is determined based on device parameters related to the terminal. For example, the device parameters include camera parameters and picture imaging parameters. The camera parameters include at least one of resolution, a focal length, a field of view, distortion, chromatic aberration, or sharpness. The picture imaging parameters are determined based on pictures actually shot by the terminal. In some embodiments, as shown in FIG. 3, the device parameters of different devices are acquired in advance, and then different devices are classified based on the device parameters, such as class A, class B, class C, and class D. Each class corresponds to acquisition box parameters, and the acquisition box parameters include at least one of a display size, a display position, or a display form that are configured to indicate that the acquisition box is displayed on an identity feature enrollment interface. The acquisition box parameters are stored in the server 120. In some embodiments, when starting the identity feature acquisition, the terminal 110 transmits a request to invoke the acquisition box parameters to the server 120. The server 120 transmits corresponding acquisition box parameters to the terminal 110 according to a class to which the terminal 110 belongs. The terminal 110 displays the acquisition box in the first display state based on the acquisition box parameters received.

In some embodiments, a display shape of the acquisition box in the first display state is preset or dynamically changed. For example, at least two display shapes of the acquisition box in the first display state are provided for being selected, including at least two of a circle, a square, and a trapezoid. A preset display shape of the acquisition box in the first display state is the circle, and a user may further choose to modify the display shape of the acquisition box in the first display state to the square. In some embodiments, the display size of the acquisition box in the first display state is preset or dynamically changed. For example, the display size of the acquisition box in the first display state is one third of the terminal screen. In some embodiments, the display position of the acquisition box in the first display state is preset or dynamically changed. For example, the acquisition box in the first display state is displayed in a center position of the terminal screen.

In some embodiments, the first display state is distinguishable from a second display state. The first display state is different from the second display state. In some embodiments, the first display state is a first color, such as black. The second display state is a second color, or a color other than the first color, such as green. In some embodiments, the first display state is a first display entity, such as a solid line. The second display state is a second display entity, or a display entity other than the first display entity, such as a dotted line.

For example, as shown in FIG. 2, the camera preview screen 11 and the acquisition box 12 in the first display state are displayed in the process of the identity feature acquisition.

Operation 240: Display, in response to determining that a body feature region is recognized in the camera preview screen, a tracking box on a screen region corresponding to the body feature region. For example, whether the body region that corresponds to a body feature is recognized in the image frames is determined. In some examples, based on the body region being recognized in the image frames, a tracking box corresponding to the body region is displayed in the camera preview screen, a shape of the tracking box changing with an angle between a first reference plane where the body region is located and a second reference plane corresponding to the acquisition box in a real space.

The body feature region refers to a region on a human body that carries human features, such as a palm region, a fingertip region, and a face region. In some embodiments, in response to determining that the body feature region is recognized in the camera preview screen, the tracking box is displayed on the screen region corresponding to the body feature region. The tracking box follows the body feature region. The tracking box is configured to box the body feature region in the camera preview screen, and the display shape, the display size, and the display position of the tracking box change following the body feature region.

In some embodiments, a display state of the tracking box is preset. In some embodiments, the display state of the tracking box is the first display state. In some examples, the display state of the tracking box is the same as a start display state of the acquisition box. In some embodiments, the display state of the tracking box is the second display state. In some examples, the display state of the tracking box is the same as a final display state of the acquisition box. In some embodiments, the display state of the tracking box is the same as a display state of the acquisition box. In some examples, when the acquisition box is in the first display state, the tracking box is also in the same first display state.

When a relative position between the tracking box and the acquisition box in the first display state satisfies a matching condition, the first display state is switched to the second display state to be displayed. In some embodiments, the display state of the tracking box is a third display state. In some examples, the display state of the tracking box is different from the display state of the acquisition box. For example, in a case that the first display state of the acquisition box is red, and the second display state of the acquisition box is green, the display state of the tracking box is yellow. In some examples, when the tracking box and the acquisition box in the first display state satisfy the matching condition, display of the acquisition box in the first display state is switched to display of an acquisition box in a second display state, the acquisition box in the second display state indicating that the body region is determined to reach the target pose in the real space.

In some embodiments, the display state of the tracking box is dynamically changed. In some embodiments, the display state of the tracking box changes with a change in a distance between the body feature region and the camera. In some embodiments, the greater the distance between the body feature region and the camera is, the greater a difference between the display state of the tracking box and the display state of the acquisition box is. The smaller the distance between the body feature region and the camera is, the smaller a difference between the display state of the tracking box and the display state of the acquisition box is. For example, assuming that the first display state of the acquisition box is red, the display state of the tracking box changes from a color close to red to a color greatly different from red (such as yellow) when the body feature region gets far away from the camera from a position close to the camera.

In some embodiments, the tracking box corresponds to a tracking sound. The tracking sound and the tracking box exist synchronously, and the tracking sound is played in linkage with display of the tracking box. In some embodiments, the tracking sound is preset. For example, the tracking sound corresponds to the display state of the tracking box, and the tracking sound is also fixed in a case that the display state of the tracking box is fixed. In some embodiments, the tracking sound and the tracking box are in one-to-one mapping. For example, the one-to-one mapping is shown in Table 1.

TABLE 1

| Tracking box | Tracking sound |
|---|---|
| Tracking box 1 | Tracking sound 1 |
| Tracking box 2 | Tracking sound 2 |
| . . . | . . . |

In some embodiments, the tracking sound is dynamically changed. For example, the tracking sound changes with the change in the tracking box. In some embodiments, urgency of the tracking sound changes with the change in the distance between the body feature region and the camera. The urgency of the tracking sound has a negative correlation with the distance between the body feature region and the camera. In a case that the body feature region gets closer to the camera, the tracking sound becomes increasingly urgent. In a case that the body feature region gets farther away from the camera, the tracking sound becomes increasingly gentle. In some embodiments, a tone of the tracking sound changes with the change in the distance between the body feature region and the camera. The tone of the tracking sound has a negative correlation with the distance between the body feature region and the camera. In a case that the body feature region gets closer to the camera, the tone becomes increasingly high. In a case that the body feature region gets farther away from the camera, the tracking sound becomes increasingly low.

In some embodiments, an effect mask is displayed while the tracking box is displayed. The effect mask is attached to the body feature region. The effect mask is configured to notify the user to notice that the tracking box is displayed, and can improve interest in guiding the user through an effect. In some embodiments, the effect mask is preset. For example, in a case that the body feature region is a palm region, the effect mask is a flower, and indicates “blossom in a palm”. In a case that the body feature region is a face region, the feature mask is a facial sticker. In some embodiments, the effect mask is dynamically changed. In some embodiments, a display effect of the effect mask may change following the change in the distance between the body feature region and the camera. For example, in a case that the body feature region is the palm region, the effect mask is the flower. In a case that the palm region moves away from the camera, the flower is displayed smaller. In a case that the palm region moves close to the camera, the flower is displayed larger.

The description of the tracking box and the tracking sound in this disclosure is provided as a non-limiting example, and any other method by which the tracking box can be displayed on the body feature region falls within the scope of this disclosure. For example, in a case that the body feature region is the palm region, the effect mask may alternatively be a fountain.

In some embodiments, the tracking box changes with a change in a pose of the body feature region in a real space. In some embodiments, the display shape of the tracking box changes with a change in a plane where the body feature region is located and the change in the distance between the body feature region and the camera.

In some embodiments, in response to determining that the body feature region is recognized in the camera preview screen, a first aspect ratio is taken as an aspect ratio of the tracking box, and the tracking box is displayed on the screen region corresponding to the body feature region. The first aspect ratio is associated with an included angle between a plane where the body feature region is located and a plane where a terminal screen is located. In some embodiments, the first aspect ratio has a positive correlation with the included angle between the plane where the body feature region is located and the plane where the terminal screen is located. In some aspects, increasing an aspect ratio of a shape may correspond to making the shape appear flatter (or understood as having greater flatness).

For example, if the included angle between the plane where the body feature region is located and the plane where the terminal screen is located is zero in the real space, the tracking box in a standard state is displayed. The standard state is a circular box. If the included angle between the plane where the body feature region is located and the plane where the terminal screen is located is gradually increased, an elliptical box is displayed. The elliptical box has a higher aspect ratio (e.g., becomes flatter) as the included angle is gradually increased. If the included angle between the plane where the body feature region is located and the plane where the terminal screen is located is gradually reduced, the displayed elliptical box becomes closer to the circular box.

In some embodiments, the tracking box is configured to track a projection of a feature box of the body feature region in the camera preview screen. The feature box is configured to box the body feature region on the plane where the body feature region is located.

In some embodiments, the body feature region is the palm region. In some embodiments, the body feature region is the face region. In an aspect of this disclosure, description is made by taking the body feature region being the palm region as an example.

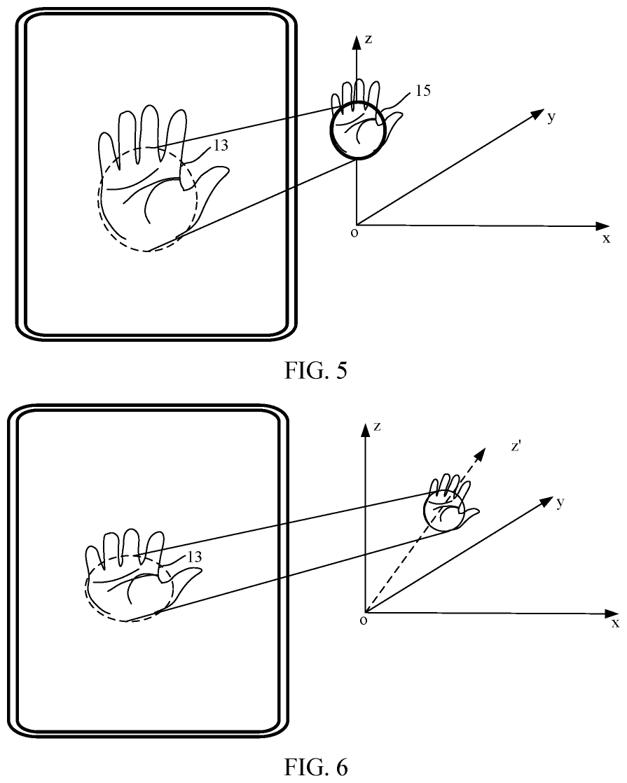

For example, as shown in FIG. 5, assuming that a plane where the terminal screen is located is an x-o-z plane. When the plane where the body feature region is located is parallel to the plane where the terminal screen is located, the tracking box 13 is the feature box 15, and the tracking box 13 and the feature box 15 are circular. When the plane where the body feature region is located intersects with the plane where the terminal screen is located, for example, as shown in FIG. 6, when the plane where the body feature region is located is an x-o-z′ plane, the tracking box 13 is a projection of the feature box 15 on the terminal screen, and the feature box 15 is circular. The tracking box 13 is elliptical after projection of the feature box 15.

In some embodiments, a shape of the feature box is the same as a shape of the acquisition box in the first display state. For example, if the shape of the acquisition box in the first display state is circular, the shape of the feature box is also circular.

In some embodiments, in response to determining that the body feature region is recognized, a reference point on the screen region corresponding to the body feature region is taken as a center point of the tracking box, and the tracking box is displayed on the screen region. In some embodiments, the reference point is a center point on the screen region corresponding to the body feature region, such as a center point of a screen region corresponding to the palm region.

In some examples, when the body region is recognized in one of the image frames, a reference point on a screen region corresponding to the body region is determined in the one of the image frames. In some examples, the tracking box is displayed based on taking the reference point as a center point of the tracking box.

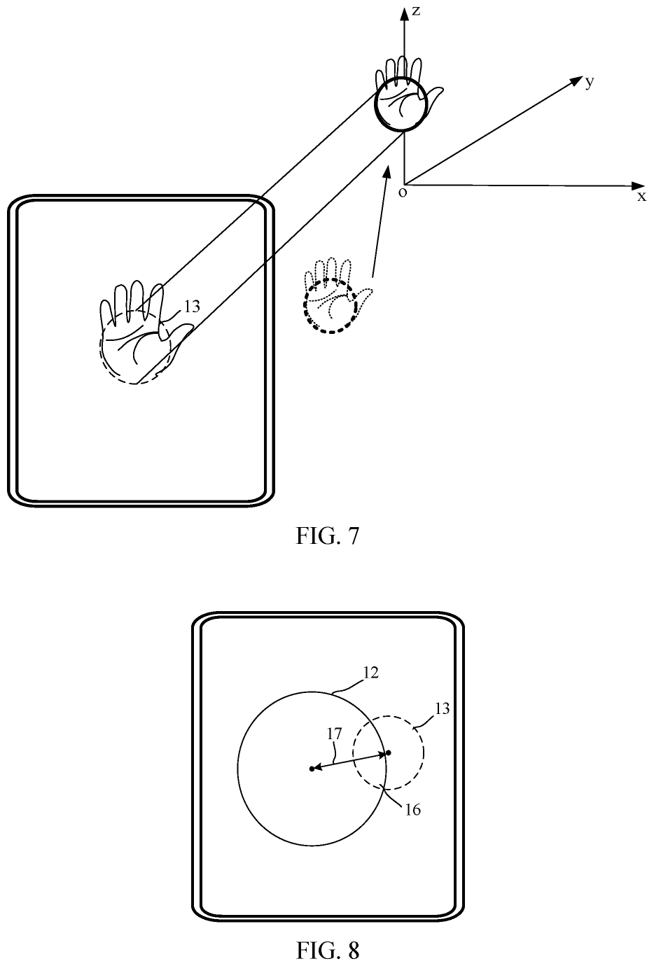

In some embodiments, in response to determining that the body feature region is recognized in the camera preview screen, a first size is taken as a size of the tracking box, and the tracking box is displayed on the screen region corresponding to the body feature region. The first size is associated with the distance between the body feature region and the camera. In some embodiments, the first size has a negative correlation with the distance between the body feature region and the camera. In some embodiments, the farther the distance between the body feature region and the camera is, the smaller the first size is. The closer the distance between the body feature region and the camera is, the larger the first size is. For example, as shown in FIG. 5 and FIG. 7, when the body feature region moves from a position closer to the camera to a position farther away from the camera, the size of the tracking box 13 is also reduced from one first size to another first size.

In some examples, when the body region is recognized in one of the image frames, a reference size associated with a distance between the body region and the camera is determined. In some examples, the tracking box is displayed based on taking the reference size as a size of the tracking box.

In some embodiments, display of the tracking box is updated in response to at least one of inclination, translation, or rotation of the body feature region following a first body part, to keep the center point of the tracking box consistent with the reference point on the screen region corresponding to the body feature region. A center point of the updated tracking box coincides with the reference point on the screen region corresponding to the body feature region. In some embodiments, the display of the tracking box is updated in response to the inclination of the body feature region following the first body part. In some embodiments, the display of the tracking box is updated in response to the translation of the body feature region following the first body part. In some embodiments, the display of the tracking box is updated in response to the rotation of the body feature region following the first body part. In some examples, the body region is at a body part and movable along with movement of the body part.

In some embodiments, the first body part is a body part where the body feature region is located. For example, in a case that the body feature region is the palm region, the first body part is the palm. For example, in a case that the body feature region is the face region, the first body part is a head. For example, in a case that the body feature region is the fingertip region, the first body part is a finger. In an aspect of this disclosure, description is made by taking the body feature region being the palm region and the first body part being the palm as an example.

In some embodiments, the reference point is a specified point on the screen region corresponding to the body feature region. In a case that the body feature region is the palm region, the reference point may be at least one of a center point, an upper edge point, a lower edge point, a left edge point, or a right edge point on a screen region corresponding to the palm region. In a case that the body feature region is the fingertip region, the reference point may be at least one of a center point, an upper edge point, a lower edge point, a left edge point, or a right edge point on a screen region corresponding to the fingertip region.

Operation 260: Determine that the pose of the body feature region in the real space reaches the acquisition pose in response to determining that the tracking box and the acquisition box in the first display state satisfy a matching condition. For example, a determination is made by processing circuitry that the body region reaches the target pose in the real space when the tracking box and the acquisition box in the first display state satisfy a matching condition. In some examples, acquisition pose notification information is displayed on the display when the body region is determined to reach the target pose in the real space.

In an aspect of this disclosure, the acquisition box in the first display state and the tracking box are displayed on the camera preview screen, and the tracking box changes with the change in the pose of the body feature region of the user in the real space. In a dynamic change process of the tracking box, if the tracking box matches the acquisition box in the first display state, the pose of the body feature region in the real space is determined to reach the acquisition pose. The acquisition pose refers to a pose that the body feature region is required to be in when the identity feature of the body feature region is acquired. In the acquisition pose, the terminal device can acquire high-quality, clear, and complete identity features.

In some embodiments, in response to determining that the tracking box and the acquisition box in the first display state satisfy the matching condition, the acquisition box in the first display state is switched to an acquisition box in a second display state to be displayed, the acquisition box in the second display state being configured to indicate that the pose of the body feature region in the real space reaches the acquisition pose. The first display state is different from the second display state.

The acquisition box in the second display state refers to a result box in a matching process. If the acquisition box in the first display state and the tracking box satisfy the matching condition, the acquisition box in the first display state is switched to the acquisition box in the second display state to be displayed. The first display state and the second display state are different display states. A case that the acquisition box in the first display state is switched to the acquisition box in the second display state to be displayed indicates that a pose of a current body feature region in the real space reaches the acquisition pose. In some examples, the pose of the current body feature region in the real space satisfies a condition. In this case, the body feature region may be subjected to feature acquisition.

In some embodiments, the matching condition includes at least one of the following:
a shape of the tracking box is the same as a shape of the acquisition box in the first display state;
the size of the tracking box is the same as a size of the acquisition box in the first display state;
a ratio of an area of the tracking box to an area of the acquisition box in the first display state is greater than or equal to a ratio threshold;
an overlapped area between the tracking box and the acquisition box in the first display state is greater than or equal to an area threshold;
a distance between a center of the tracking box and a center of the acquisition box in the first display state is less than a distance threshold;
a difference between a radius of the tracking box and a radius of the acquisition box in the first display state is less than a length difference threshold; and
an included angle between a plane where the tracking box is located and a plane where the acquisition box is located in the first display state is less than an angle difference threshold.

In some embodiments, in response to determining that the shape of the tracking box is the same as the shape of the acquisition box in the first display state, the acquisition box in the first display state is switched to the acquisition box in the second display state to be displayed. The tracking box is the projection of the feature box in the camera preview screen. Thus, when the plane where the body feature region is located is parallel to the plane where the terminal screen is located, the shape of the tracking box is the same as the shape of the acquisition box in the first display state. In this case, the acquisition box in the first display state is switched to the acquisition box in the second display state to be displayed.

In some embodiments, in response to determining that the size of the tracking box is the same as the size of the acquisition box in the first display state, the acquisition box in the first display state is switched to the acquisition box in the second display state to be displayed. The size of the tracking box herein may be understood as an area size of the tracking box. In some examples, in response to determining that an area size of the tracking box is the same as an area size of the acquisition box in the first display state, the acquisition box in the first display state is switched to the acquisition box in the second display state to be displayed. Alternatively, the size of the tracking box herein may alternatively be understood as the size of the tracking box in a case that the shape of the tracking box is the same as the shape of the acquisition box in the first display state. In some examples, in response to determining that the shape of the tracking box is the same as the shape of the acquisition box in the first display state, and the size of the tracking box is the same as the size of the acquisition box in the first display state, the acquisition box in the first display state is switched to the acquisition box in the second display state to be displayed.

In some embodiments, in response to determining that the ratio of the area of the tracking box to the area of the acquisition box in the first display state is greater than or equal to the ratio threshold, the acquisition box in the first display state is switched to the acquisition box in the second display state to be displayed. The area of the acquisition box in the first display state remains unchanged after the acquisition box in the first display state is displayed. The area of the tracking box changes with update of the tracking box. In some embodiments, the ratio threshold is preset or dynamically changed. For example, if the ratio threshold is four fifths, the acquisition box in the first display state is switched to the acquisition box in the second display state to be displayed in response to determining that the ratio of the area of the tracking box to the area of the acquisition box in the first display state is greater than or equal to four fifths.

In some embodiments, in response to determining that the overlapped area between the tracking box and the acquisition box in the first display state is greater than or equal to the area threshold, the acquisition box in the first display state is switched to the acquisition box in the second display state to be displayed. In some embodiments, the area threshold is preset or dynamically changed. For example, the area threshold is 2 square centimeters. For example, as shown in FIG. 8, in response to determining that the area of an overlapped region 16 between the tracking box 13 and the acquisition box 12 in the first display state is greater than or equal to 2 square centimeters, the acquisition box 12 in the first display state is switched to the acquisition box in the second display state to be displayed.

In some embodiments, in response to determining that the distance between the center of the tracking box and the center of the acquisition box in the first display state is less than the distance threshold, the acquisition box in the first display state is switched to the acquisition box in the second display state to be displayed. In some embodiments, the distance threshold is preset or dynamically changed. For example, the distance threshold is 2 centimeters. For example, as shown in FIG. 8, in response to determining that the distance 17 between the center of the tracking box 13 and the center of the acquisition box 12 in the first display state is less than 2 centimeters, the acquisition box 12 in the first display state is switched to the acquisition box in the second display state to be displayed.

In some embodiments, in a case that the acquisition box in the first display state is circular and the tracking box is circular, in response to determining that the difference between the radius of the tracking box and the radius of the acquisition box in the first display state is less than the length difference threshold, the acquisition box in the first display state is switched to the acquisition box in the second display state to be displayed. In some embodiments, the length difference threshold is preset or dynamically changed. For example, the length difference threshold is 1 centimeter. In response to determining that the difference between the radius of the tracking box and the radius of the acquisition box in the first display state is less than 1 centimeter, the acquisition box in the first display state is switched to the acquisition box in the second display state to be displayed. In a case that the acquisition box in the first display state is circular and the tracking box is circular, for example, the shape of the acquisition box in the first display state is the same as the shape of the tracking box, and the plane where the body feature region is located is parallel to the plane where the terminal screen is located.

In some embodiments, in response to determining that the included angle between the plane where the body feature region is located and the plane where the acquisition box in the first display state is located is less than the angle difference threshold, the acquisition box in the first display state is switched to the acquisition box in the second display state to be displayed. Alternatively, in response to determining that the included angle between the plane where the feature box is located and the plane where the terminal screen is located is less than the angle difference threshold, the acquisition box in the first display state is switched to the acquisition box in the second display state to be displayed. The tracking box is the projection of the feature box on the plane where the terminal screen is located. In some embodiments, the angle difference threshold is preset or dynamically changed. For example, the angle difference threshold is 30 degrees. In response to determining that the included angle between the plane where the body feature region is located and the plane where the acquisition box in the first display state is located is less than 30 degrees, the acquisition box in the first display state is switched to the acquisition box in the second display state to be displayed.

In some embodiments, the matching condition may be a combination of n conditions described above, and n is an integer greater than 1. For example, the matching condition includes that the shape of the tracking box is the same as the shape of the acquisition box in the first display state, and the ratio of the area of the tracking box to the area of the acquisition box in the first display state is greater than or equal to the ratio threshold. Then, in response to determining that the shape of the tracking box is the same as the shape of the acquisition box in the first display state, and the ratio of the area of the tracking box to the area of the acquisition box in the first display state is greater than or equal to the ratio threshold, the acquisition box in the first display state is switched to the acquisition box in the second display state to be displayed.

Accordingly, the embodiments of this disclosure provide a method for acquiring the identity features. Since the tracking box changes with the change in the pose of the body feature region in the real space, the user can be guided to adjust the pose of the body feature region by guiding the user to adjust the tracking box. Further, by guiding the user to adjust the tracking box to satisfy the matching condition with the acquisition box in the first display state, the user can perform adjustment based on the visualized guidance information, and efficiency of identity feature acquisition by the user can be improved.

According to the method provided by the embodiments of this disclosure, the tracking box is further displayed by taking the reference point on the screen region corresponding to the body feature region as the center point of the tracking box. Thus, the tracking box always changes based on the change in the body feature region. The tracking box can be adjusted in time when the body feature region changes dynamically. For example, the tracking box can be updated in time when the body feature region undergoes the inclination, translation, or rotation following the first body part. Thus, real-time guidance is provided for the user.

According to the method provided by the embodiments of this disclosure, the tracking box is further displayed by taking the first size as the size of the tracking box. Thus, the size of the tracking box is determined according to the distance between the body feature region and the camera. The size of the tracking box can be dynamically adjusted, such that real-time guidance is provided for the user.

According to the method provided by the embodiments of this disclosure, the tracking box is further displayed by taking the first aspect ratio as an aspect ratio of the tracking box. Thus, the aspect ratio of the tracking box is determined according to the included angle between the plane where the body feature region is located and the plane where the terminal screen is located. The aspect ratio of the tracking box can be dynamically adjusted, such that real-time guidance is provided for the user.

In some examples, when the body region is recognized in one of the image frames, a reference aspect ratio associated with the angle between the first reference plane and the second reference plane is determined. In some examples, the tracking box is displayed based on taking the reference aspect ratio as an aspect ratio of the tracking box.

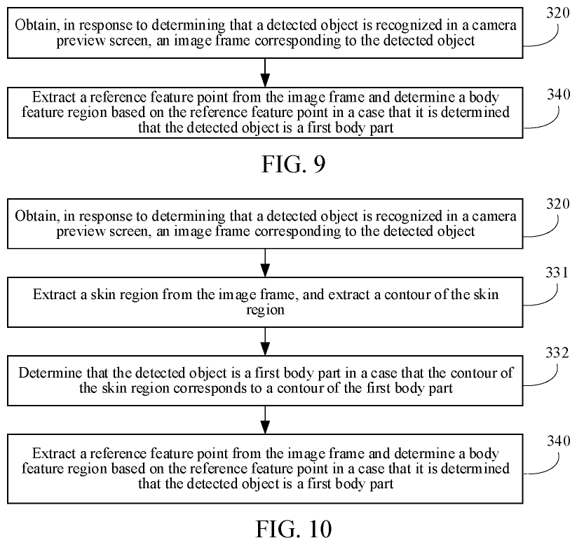

FIG. 9 shows a flowchart of a method for determining an acquisition pose according to an embodiment of this disclosure. The method being performed by the terminal 110 shown in FIG. 1 is taken as an example. Before operation 240, the method further includes the following operations:

Operation 320: Obtain, in response to determining that a detected object is recognized in the camera preview screen, an image frame corresponding to the detected object.

The detected object is a skin region in some embodiments. In some embodiments, the detected object is the first body part or the detected object is not the first body part. In some embodiments, in response to determining that the first body part is recognized in the camera preview screen, an image frame corresponding to the first body part is obtained. Alternatively, in response to determining that an object other than the first body part is recognized in the camera preview screen, an image frame corresponding to the recognized object is obtained.

In some embodiments, the image frame is a preprocessed image frame. In some embodiments, a preprocessing operation includes at least one of color space conversion, binarization, filtering, or edge detection. In some embodiments, the image frame is an unpreprocessed image frame. The preprocessing operation is configured to reduce noise and background interference in the image frame, and a feature in the image frame is highlighted.

In some embodiments, it is determined whether the detected object is the first body part based on the obtained image frame. For example, as shown in FIG. 10, the method further includes the following operations:

Operation 331: Extract a skin region from the image frame, and extract a contour of the skin region.

In some embodiments, the skin region in the image frame is extracted based on a color threshold. In some embodiments, the image frame is converted from a first color space to a second color space, and information about colors in the first color space and information about colors in the second color space are different. For example, the first color space is a red green blue (RGB) color space, and the second color space is a hue saturation value (HSV) color space.

In some embodiments, the color threshold is preset. The color threshold is configured to distinguish a skin region from a non-skin region in the image frame. In some embodiments, in a case that a color difference between the skin region and the non-skin region in the image frame is significant, the skin region in the image frame is directly extracted. In some embodiments, in a case that a color difference between the skin region and the non-skin region in the image frame is insignificant, the image frame is converted from the first color space to the second color space, the color difference between the skin region and the non-skin region in the image frame is highlighted, and the skin region is extracted from the image frame.

In some embodiments, the contour of the skin region is extracted through an edge detection algorithm. In some embodiments, the contour of the skin region is extracted through a Canny algorithm. In some embodiments, the contour of the skin region is extracted by a Sobel algorithm. In some embodiments, the Canny algorithm is a standard algorithm widely applied to edge detection, and aims at finding an optimal edge detection solution or finding a position with a strongest gray scale intensity change in an image. An optimal edge detection is used for evaluation through three criteria of a low error rate, high localization, and minimum response. In some embodiments, the Sobel algorithm is used for the edge detection. Technically, an approximate value of a gray scale of an image brightness function is calculated through a set of discrete difference operators.

In some embodiments, whether the detected object is the first body part is determined according to the contour of the skin region.

Operation 332: Determine that the detected object is the first body part in a case that the contour of the skin region corresponds to a contour of the first body part.

In some embodiments, the contour of the skin region is compared with the contour of the first body part, and it is determined that the detected object is the first body part in a case that the contour of the skin region corresponds to the contour of the first body part. In a case that the contour of the skin region does not correspond to the contour of the first body part, it is determined that the detected object is not the first body part.

In some embodiments, the contour of the first body part corresponds to features such as a shape, an area, and a perimeter. In some embodiments, it is determined whether the detected object is the first body part by comparing the shape of the contour of the skin region with the shape of the contour of the first body part. In some embodiments, mapping exists between the features of the contour of the first body part. For example, in a case that a corresponding area of the contour of the first body part is 10 square centimeters, a corresponding perimeter is 15 centimeters. In a case that a corresponding area of the contour of the first body part is 20 square centimeters, a corresponding perimeter is 30 centimeters.

In some embodiments, in a case that it is determined that the detected object is the first body part, operation 340 below is continuously performed. In a case that it is determined that the detected object is not the first body part, the above operations are repeated until it is determined that the detected object is the first body part.

Operation 340: Extract a reference feature point from the image frame and determine the body feature region based on the reference feature point in a case that it is determined that the detected object is the first body part. For example, one or more reference feature points are extracted from one of the image frames when a detected object is recognized in the one of the image frames. In some examples, the body region is determined based on the one or more reference feature points when the detected object is recognized as a body part.

In some embodiments, in a case that it is determined that the detected object is the first body part, the reference feature points are extracted from the image frame. In some embodiments, the reference feature points include a first body part convex point and a first body part concave point.

In some embodiments, the first body part convex point refers to a feature point corresponding to a relative convex position in the first body part, such as a fingertip position. The first body part concave point refers to a feature point corresponding to a relative concave position in the first body part, such as a knuckle position. In some embodiments, with the first body part being the palm as an example, positions where the first body part convex points are located include the fingertip position, a center position of the knuckle, and a center position of a finger base joint. Positions where the first body part concave points are located include a knuckle position, a finger base position, and a center position of the palm.

In some embodiments, the body feature region is determined based on the reference feature points. The body feature region is a region other than fingers in the first body part, or the body feature region is a region including the identity features. In some embodiments, a boundary line between the fingers and the body feature region is determined based on the reference feature point. Based on the boundary line and the contour of the first body part, the body feature region is determined.

Accordingly, based on the one or more methods described in this disclosure, the image frame corresponding to the detected object is obtained in response to determining that the detected object is recognized in the camera preview screen. The skin region in the image frame, and the contour corresponding to the skin region are extracted, and whether the detected object is the first body part is determined. Thus, the method provided by the embodiments of this disclosure can accurately acquire the identity feature. In a case that the detected object is not the first body part, repeated recognition is needed instead of an invalid operation of extracting the reference feature point. Thus, the invalid operation in a case that the detected object is not the first body part can be reduced, and accuracy of identity feature acquisition can be improved.

In some embodiments, in the process of the identity feature acquisition, the terminal notifies the user through at least one piece of notification information. In some embodiments, the notification information includes at least one of the following:
first notification information;
second notification information; and
third notification information.

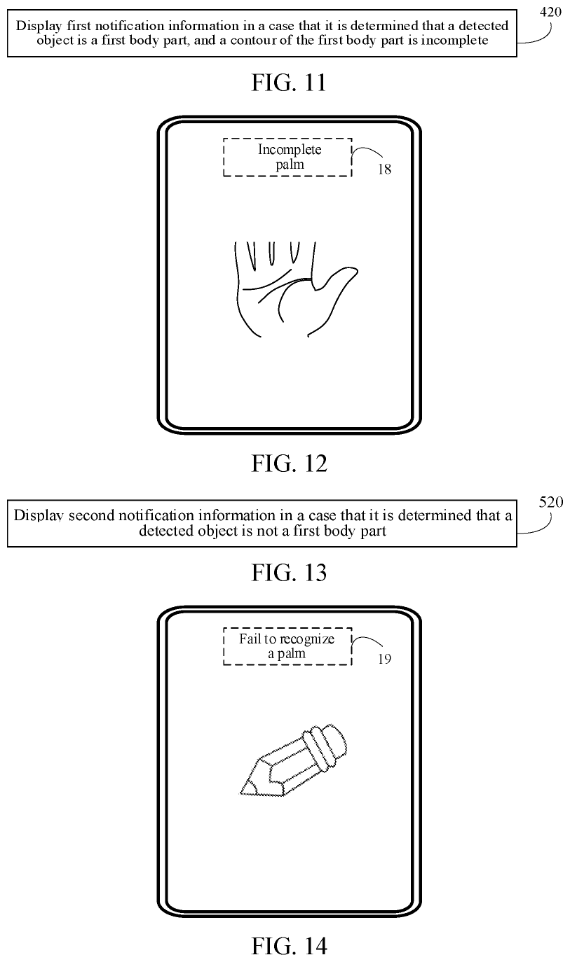

In some embodiments, the first notification information is configured to notify the user to adjust the position of the first body part. For example, as shown in FIG. 11, the method further includes the following operations:

Operation 420: Display the first notification information in a case that it is determined that the detected object is the first body part, and the contour of the first body part is incomplete.

Operation 420 is performed after operation 332. In an example, in a case that the detected object is determined to be the first body part, whether the first body part is complete is determined by analyzing the contour of the first body part. In some embodiments, whether the contour of the first body part is interrupted is determined by calculating a ratio of the area to the perimeter of the contour of the first body part. For example, in a case that the contour of the first body part is uninterrupted, the ratio of the area to the perimeter of the contour of the first body part is 1:1.5. Then, the contour of the first body part can be determined to be interrupted in a case that the calculated ratio of the area to the perimeter of the contour of the first body part is 1:1.

In some embodiments, in a case that the contour of the first body part is incomplete, the body feature region may not be accurately recognized. For example, in a case that the contour of the first body part merely includes a contour of fingers, the body feature region may not be recognized. Thus, in a case that the detected object is determined to be the first body part and the contour of the first body part is incomplete, the first notification information is displayed. The user is reminded to adjust the position of the first body part through the first notification information. Thus, the complete contour of the first body part can be recognized, and the body feature region can be more accurately recognized.

For example, as shown in FIG. 12, assuming that the first body part is a palm, in a case that it is determined that the detected object is the palm, and the contour of the palm is incomplete, the first notification information 18 is displayed. The first notification information 18 is configured to notify the user to notice that “the palm is incomplete”.

In some embodiments, the second notification information is configured to notify to replace the detected object. For example, as shown in FIG. 13, the method further includes the following operations:

Operation 520: Display the second notification information in a case that it is determined that the detected object is not the first body part.

In some embodiments, after operation 331, in a case that it is determined that the detected object is not the first body part, the second notification information is displayed. Alternatively, in response to determining that the recognized detected object is a target object, and the target object is not the first body part, the second notification information is displayed.

For example, as shown in FIG. 14, assuming that the first body part is the palm, in a case that it is determined that the detected object is not the palm, and the second notification information 19 is displayed. The second notification information 19 is configured to notify the user to notice that “the palm is not recognized”.

In some embodiments, in a case that it is repeatedly determined that the detected object is not the first body part, the second notification information is repeatedly displayed until the user replaces the detected object with the first body part.

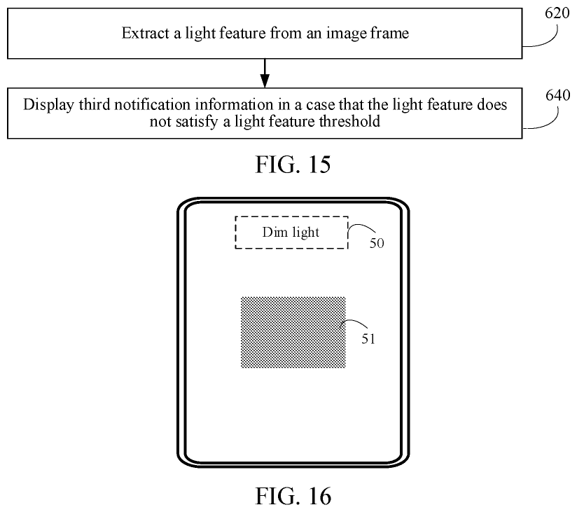

In some embodiments, the third notification information is configured to notify to adjust light of the image frame. For example, as shown in FIG. 15, the method further includes the following operations:

Operation 620: Extract a light feature from the image frame.

In some embodiments, after operation 320, for example, after the image frame of the detected object is obtained, the light features in the image frame are extracted. In some embodiments, the light features include brightness and chroma. In some embodiments, the brightness of the light in the image frame is extracted. In some embodiments, the chroma of the light in the image frame is extracted.

Operation 640: Display the third notification information in a case that the light feature does not satisfy a light feature threshold.

In some embodiments, the extracted light feature is compared with the light feature threshold, and in a case that the light feature satisfies the light feature threshold, it is determined that the light in the image frame satisfies the condition, and operation 331 is continuously performed. In a case that the light feature does not satisfy the light feature threshold, it is determined that the light in the image frame does not satisfy the condition, and the third notification information is displayed. In some embodiments, the light feature threshold is preset or dynamically adjusted. The third notification information is configured to notify to adjust an illumination condition of the real space under which the image frame is taken.

For example, as shown in FIG. 16, in a case that the light feature in the image frame does not satisfy the light feature threshold, or in a case that the light in the obtained acquired image 51 is less or dim, the third notification information 50 is displayed. The third notification information 50 is configured to notify the user to notice that “the light is dim”, or to notify the user to adjust light in current acquisition environment.

According to the method provided by the embodiments of this disclosure, the user is notified by displaying at least one piece of notification information. Thus, the user can be reminded to perform adjustment according to various situations in the process of the identity feature acquisition in time, and the process of the identity feature acquisition can proceed more smoothly.

In some embodiments, with the process of the palm print acquisition as an example, the method includes the following operations:

Operation 2020: Display a camera preview screen and an acquisition box in a first display state in a process of palm print acquisition.

In some embodiments, the camera preview screen and the acquisition box in the first display state are displayed in response to a trigger operation on a palm print acquisition client. The trigger operation includes at least one of single click, double click, left-right slide, up-down slide, long press, hover, face recognition, or voice recognition. The trigger operation includes, but is not limited to, the types described above. Those of ordinary skill in the art are to be able to know that any operation that can implement the functions described above falls within the scope of this disclosure.

In some embodiments, the camera preview screen and the acquisition box in the first display state are displayed simultaneously. In some embodiments, the camera preview screen and the acquisition box in the first display state are not displayed simultaneously. In some embodiments, the acquisition box in the first display state is displayed after the camera preview screen is displayed. For example, the camera preview screen is displayed at first, and then the acquisition box in the first display state is displayed after a detected object is recognized. In some embodiments, the camera preview screen is displayed after the acquisition box in the first display state is displayed.

In some embodiments, the camera preview screen is a screen shot by a camera in real time. In some embodiments, the camera preview screen is displayed in full screen on a terminal screen. In some embodiments, the camera preview screen is displayed in a target region on the terminal screen. The target region is preset or the target region is dynamically changed. For example, the target region is a one-third region in a middle of the terminal screen. In an aspect of this disclosure, description is made by taking the camera preview screen being displayed in full screen on the terminal screen as an example.

In some embodiments, the acquisition box in the first display state is determined based on device parameters related to the terminal. For example, the device parameters include camera parameters and picture imaging parameters. The camera parameters include at least one of resolution, a focal length, a field of view, distortion, chromatic aberration, or sharpness. The picture imaging parameters are determined based on pictures actually shot by the terminal. In some embodiments, as shown in FIG. 3, the device parameters of different devices are acquired in advance, and then different devices are classified based on the device parameters, such as class A, class B, class C, and class D. Each class corresponds to acquisition box parameters, and the acquisition box parameters include at least one of a display size, a display position, or a display form that are configured to indicate that the acquisition box is displayed on a palm print enrollment interface. The acquisition box parameters are stored in the server 120. In some embodiments, when starting the palm print acquisition, the terminal 110 transmits a request to invoke the acquisition box parameters to the server 120. The server 120 transmits corresponding acquisition box parameters to the terminal 110 according to a class to which the terminal 110 belongs. The terminal 110 displays the acquisition box in the first display state based on the acquisition box parameters received.

In some embodiments, a display shape of the acquisition box in the first display state is preset or dynamically changed. For example, at least two display shapes of the acquisition box in the first display state are provided for being selected, including at least two of a circle, a square, and a trapezoid. A preset display shape of the acquisition box in the first display state is the circle, and a user may alternatively choose to modify the display shape of the acquisition box in the first display state to the square. In some embodiments, the display size of the acquisition box in the first display state is preset or dynamically changed. For example, the display size of the acquisition box in the first display state is one third of the terminal screen. In some embodiments, the display position of the acquisition box in the first display state is preset or dynamically changed. For example, the acquisition box in the first display state is displayed in a center position of the terminal screen.

In some embodiments, the first display state is configured to being distinguished from a second display state. The first display state is different from the second display state. In some embodiments, the first display state is a first color, such as black. The second display state is a second color, or a color other than the first color, such as green. In some embodiments, the first display state is a first display entity, such as a solid line. The second display state is a second display entity, or a display entity other than the first display entity, such as a dotted line.

For example, as shown in FIG. 2, the camera preview screen 11 and the acquisition box 12 in the first display state are displayed in the process of the palm print acquisition.

Operation 2040: Display, in response to determining that a palm region is recognized in the camera preview screen, a tracking box on a screen region corresponding to the palm region.

In some embodiments, in response to determining that the palm region is recognized in the camera preview screen, the tracking box is displayed on the screen region corresponding to the palm region. The tracking box follows the palm region. The tracking box is configured to box the palm region in the camera preview screen, and the display shape, the display size, and the display position of the tracking box change following the palm region.

In some embodiments, a display state of the tracking box is preset. In some embodiments, the display state of the tracking box is the first display state. In some examples, the display state of the tracking box is the same as a start display state of the acquisition box. In some embodiments, the display state of the tracking box is the second display state. In some examples, the display state of the tracking box is the same as a final display state of the acquisition box. In some embodiments, the display state of the tracking box is the same as a display state of the acquisition box. In some examples, when the acquisition box is in the first display state, the tracking box is also in the same first display state. When a relative position between the tracking box and the acquisition box in the first display state satisfies a matching condition, the first display state is switched to the second display state to be displayed. In some embodiments, the display state of the tracking box is a third display state. In some examples, the display state of the tracking box is different from the display state of the acquisition box. For example, in a case that the first display state of the acquisition box is red, and the second display state of the acquisition box is green, the display state of the tracking box is yellow.

In some embodiments, the display state of the tracking box is dynamically changed. In some embodiments, the display state of the tracking box changes with a change in a distance between the palm region and the camera. In some embodiments, the greater the distance between the palm region and the camera is, the greater a difference between the display state of the tracking box and the display state of the acquisition box is. The smaller the distance between the palm region and the camera is, the smaller a difference between the display state of the tracking box and the display state of the acquisition box is. For example, assuming that the first display state of the acquisition box is red, the display state of the tracking box changes from a color close to red to a color greatly different from red (such as yellow) when the palm region gets far away from the camera from a position close to the camera.

In some embodiments, the tracking box corresponds to a tracking sound. The tracking sound and the tracking box exist synchronously, and the tracking sound is played in linkage with display of the tracking box. In some embodiments, the tracking sound is preset. For example, the tracking sound corresponds to the display state of the tracking box, and the tracking sound is also fixed in a case that the display state of the tracking box is fixed. In some embodiments, the tracking sound and the tracking box are in one-to-one mapping.

In some embodiments, the tracking sound is dynamically changed. For example, the tracking sound changes with the change in the tracking box. In some embodiments, urgency of the tracking sound changes with the change in the distance between the palm region and the camera. The urgency of the tracking sound has a negative correlation with the distance between the palm region and the camera. In a case that the palm region gets closer to the camera, the tracking sound becomes increasingly urgent. In a case that the palm region gets farther away from the camera, the tracking sound becomes increasingly gentle. In some embodiments, a tone of the tracking sound changes with the change in the distance between the palm region and the camera. The tone of the tracking sound has a negative correlation with the distance between the palm region and the camera. In a case that the palm region gets closer to the camera, the tone becomes increasingly high. In a case that the palm region gets farther away from the camera, the tracking sound becomes increasingly low.

In some embodiments, an effect mask is displayed while the tracking box is displayed. The effect mask is attached to the palm region. The effect mask is configured to notify the user to notice that the tracking box is displayed, and can improve interest in guiding the user through an effect. In some embodiments, the effect mask is preset. For example, the effect mask is a flower, and indicates “blossom in a palm”. In some embodiments, the effect mask is dynamically changed. In some embodiments, a display effect of the effect mask may change following the change in the distance between the palm region and the camera. For example, in a case that the body feature region is the palm region, the effect mask is the flower. In a case that the palm region moves away from the camera, the flower is displayed smaller. In a case that the palm region moves close to the camera, the flower is displayed larger.

In some embodiments, the tracking box changes with a change in a pose of the palm region in a real space. In some embodiments, the display shape of the tracking box changes with a change in a plane where the palm region is located and the change in the distance between the palm region and the camera.

In some embodiments, in response to determining that the palm region is recognized in the camera preview screen, first aspect ratio is taken as aspect ratio of the tracking box, and the tracking box is displayed on the screen region corresponding to the palm region. The first aspect ratio is associated with an included angle between a plane where the palm region is located and a plane where a terminal screen is located. In some embodiments, the first aspect ratio has a positive correlation with the included angle between the plane where the palm region is located and the plane where the terminal screen is located.

For example, if the included angle between the plane where the palm region is located and the plane where the terminal screen is located is zero in the real space, the tracking box in a standard state is displayed. The standard state is a circular box. If the included angle between the plane where the palm region is located and the plane where the terminal screen is located is gradually increased, an elliptical box is displayed. The elliptical box has a higher aspect ratio as the included angle is gradually increased. If the included angle between the plane where the body feature region is located and the plane where the terminal screen is located is gradually reduced, the displayed elliptical box becomes closer to the circular box.

In some embodiments, the tracking box is configured to track a projection of a feature box of the palm region in the camera preview screen. The feature box is configured to box the palm region on the plane where the palm region is located.

For example, as shown in FIG. 5, assuming that a plane where the terminal screen is located is an x-o-z plane. When the plane where the palm region is located is parallel to the plane where the terminal screen is located, the tracking box 13 is the feature box 15, and the tracking box 13 and the feature box 15 are circular. When the plane where the palm region is located intersects with the plane where the terminal screen is located, for example, as shown in FIG. 6, when the plane where the palm region is located is an x-o-z′ plane, the tracking box 13 is a projection of the feature box 15 on the terminal screen, and the feature box 15 is circular. The tracking box 13 is elliptical after projection of the feature box 15.

In some embodiments, a shape of the feature box is the same as a shape of the acquisition box in the first display state. For example, if the shape of the acquisition box in the first display state is circular, the shape of the feature box is also circular.

In some embodiments, in response to determining that the palm region is recognized, a reference point on the screen region corresponding to the palm region is taken as a center point of the tracking box, and the tracking box is displayed. In some embodiments, the reference point is a center point on the screen region corresponding to the palm region.

In some embodiments, in response to determining that the palm region is recognized in the camera preview screen, a first size is taken as a size of the tracking box, and the tracking box is displayed on the screen region corresponding to the body feature region. The first size is associated with the distance between the palm region and the camera. In some embodiments, the first size has a negative correlation with the distance between the palm region and the camera. In some embodiments, the farther the distance between the palm region and the camera is, the smaller the first size is. The closer the distance between the palm region and the camera is, the larger the first size is. For example, as shown in FIG. 5 and FIG. 7, when the palm region moves from a position closer to the camera to a position farther away from the camera, the size of the tracking box 13 is also reduced from one first size to another first size.

In some embodiments, display of the tracking box is updated in response to at least one of inclination, translation, or rotation of the palm region following a palm, to keep the center point of the tracking box consistent with the reference point on the screen region corresponding to the palm region. A center point of the updated tracking box coincides with the reference point on the screen region corresponding to the palm region. In some embodiments, the display of the tracking box is updated in response to the inclination of the palm region following the palm. In some embodiments, the display of the tracking box is updated in response to the translation of the palm region following the palm. In some embodiments, the display of the tracking box is updated in response to the rotation of the palm region following the palm.

In some embodiments, the reference point is a specified point on the screen region corresponding to the palm region. For example, the reference point may be at least one of a center point, an upper edge point, a lower edge point, a left edge point, or a right edge point on a screen region corresponding to the palm region.

Operation 2060: Determine that the pose of the palm print region in the real space reaches the acquisition pose in response to determining that the tracking box and the acquisition box in the first display state satisfy a matching condition.

In an aspect of this disclosure, the acquisition box in the first display state and the tracking box are displayed on the camera preview screen, and the tracking box changes with the change in the pose of the palm print region of the user in the real space. In a dynamic change process of the tracking box, if the tracking box matches the acquisition box in the first display state, the pose of the palm print region in the real space is determined to reach the acquisition pose. The acquisition pose refers to a pose that the palm print region is required to be in when the identity feature of the palm print region is acquired. In the acquisition pose, the terminal device can acquire high-quality, clear, and complete identity features.

In some embodiments, in response to determining that the tracking box and the acquisition box in the first display state satisfy the matching condition, the acquisition box in the first display state is switched to an acquisition box in a second display state to be displayed, the acquisition box in the second display state being configured to indicate that the pose of the palm print region in the real space reaches the acquisition pose. The first display state is different from the second display state.

The acquisition box in the second display state refers to a result box in a matching process. If the acquisition box in the first display state and the tracking box satisfy the matching condition, the acquisition box in the first display state is switched to the acquisition box in the second display state to be displayed. The first display state and the second display state are different display states. A case that the acquisition box in the first display state is switched to the acquisition box in the second display state to be displayed indicates that a pose of a current palm print region in the real space reaches the acquisition pose. In some examples, the pose of the current palm print region in the real space satisfies a condition. In this case, the palm print region may be subjected to feature acquisition.

In some embodiments, the matching condition includes at least one of the following:
a shape of the tracking box is the same as a shape of the acquisition box in the first display state;
the size of the tracking box is the same as a size of the acquisition box in the first display state;
a ratio of an area of the tracking box to an area of the acquisition box in the first display state is greater than or equal to a ratio threshold;
an overlapped area between the tracking box and the acquisition box in the first display state is greater than or equal to an area threshold;
a distance between a center of the tracking box and a center of the acquisition box in the first display state is less than a distance threshold;
a difference between a radius of the tracking box and a radius of the acquisition box in the first display state is less than a length difference threshold; and
an included angle between a plane where the tracking box is located and a plane where the acquisition box is located in the first display state is less than an angle difference threshold.

In some embodiments, in response to determining that the shape of the tracking box is the same as the shape of the acquisition box in the first display state, the acquisition box in the first display state is switched to the acquisition box in the second display state to be displayed. The tracking box is the projection of the feature box in the camera preview screen. Thus, when the plane where the palm region is located is parallel to the plane where the terminal screen is located, the shape of the tracking box is the same as the shape of the acquisition box in the first display state. In this case, the acquisition box in the first display state is switched to the acquisition box in the second display state to be displayed.

In some embodiments, in response to determining that the size of the tracking box is the same as the size of the acquisition box in the first display state, the acquisition box in the first display state is switched to the acquisition box in the second display state to be displayed. The size of the tracking box herein may be understood as an area size of the tracking box. In some examples, in response to determining that an area size of the tracking box is the same as an area size of the acquisition box in the first display state, the acquisition box in the first display state is switched to the acquisition box in the second display state to be displayed. Alternatively, the size of the tracking box herein may alternatively be understood as the size of the tracking box in a case that the shape of the tracking box is the same as the shape of the acquisition box in the first display state. In some examples, in response to determining that the shape of the tracking box is the same as the shape of the acquisition box in the first display state, and the size of the tracking box is the same as the size of the acquisition box in the first display state, the acquisition box in the first display state is switched to the acquisition box in the second display state to be displayed.

In some embodiments, in response to determining that the ratio of the area of the tracking box to the area of the acquisition box in the first display state is greater than or equal to the ratio threshold, the acquisition box in the first display state is switched to the acquisition box in the second display state to be displayed. The area of the acquisition box in the first display state remains unchanged after the acquisition box in the first display state is displayed. The area of the tracking box changes with update of the tracking box. In some embodiments, the ratio threshold is preset or dynamically changed. For example, if the ratio threshold is four fifths, the acquisition box in the first display state is switched to the acquisition box in the second display state to be displayed in response to determining that the ratio of the area of the tracking box to the area of the acquisition box in the first display state is greater than or equal to four fifths.

In some embodiments, in response to determining that the overlapped area between the tracking box and the acquisition box in the first display state is greater than or equal to the area threshold, the acquisition box in the first display state is switched to the acquisition box in the second display state to be displayed. In some embodiments, the area threshold is preset or dynamically changed. For example, the area threshold is 2 square centimeters. For example, as shown in FIG. 8, in response to determining that the area of an overlapped region 16 between the tracking box 13 and the acquisition box 12 in the first display state is greater than or equal to 2 square centimeters, the acquisition box 12 in the first display state is switched to the acquisition box in the second display state to be displayed.

In some embodiments, in response to determining that the distance between the center of the tracking box and the center of the acquisition box in the first display state is less than the distance threshold, the acquisition box in the first display state is switched to the acquisition box in the second display state to be displayed. In some embodiments, the distance threshold is preset or dynamically changed. For example, the distance threshold is 2 centimeters. For example, as shown in FIG. 8, in response to determining that the distance 17 between the center of the tracking box 13 and the center of the acquisition box 12 in the first display state is less than 2 centimeters, the acquisition box 12 in the first display state is switched to the acquisition box in the second display state to be displayed.

In some embodiments, in a case that the acquisition box in the first display state is circular and the tracking box is circular, in response to determining that the difference between the radius of the tracking box and the radius of the acquisition box in the first display state is less than the length difference threshold, the acquisition box in the first display state is switched to the acquisition box in the second display state to be displayed. In some embodiments, the length difference threshold is preset or dynamically changed. For example, the length difference threshold is 1 centimeter. In response to determining that the difference between the radius of the tracking box and the radius of the acquisition box in the first display state is less than 1 centimeter, the acquisition box in the first display state is switched to the acquisition box in the second display state to be displayed. In a case that the acquisition box in the first display state is circular and the tracking box is circular, for example, the shape of the acquisition box in the first display state is the same as the shape of the tracking box, and the plane where the palm region is located is parallel to the plane where the terminal screen is located.

In some embodiments, in response to determining that the included angle between the plane where the palm region is located and the plane where the acquisition box in the first display state is located is less than the angle difference threshold, the acquisition box in the first display state is switched to the acquisition box in the second display state to be displayed. Alternatively, in response to determining that the included angle between the plane where the feature box is located and the plane where the terminal screen is located is less than the angle difference threshold, the acquisition box in the first display state is switched to the acquisition box in the second display state to be displayed. The tracking box is the projection of the feature box on the plane where the terminal screen is located. In some embodiments, the angle difference threshold is preset or dynamically changed. For example, the angle difference threshold is 30 degrees. In response to determining that the included angle between the plane where the palm region is located and the plane where the acquisition box in the first display state is located is less than 30 degrees, the acquisition box in the first display state is switched to the acquisition box in the second display state to be displayed.

In some embodiments, the matching condition may be a combination of n conditions described above, and n is an integer greater than 1. For example, the matching condition includes that the shape of the tracking box is the same as the shape of the acquisition box in the first display state, and the ratio of the area of the tracking box to the area of the acquisition box in the first display state is greater than or equal to the ratio threshold. Then, in response to determining that the shape of the tracking box is the same as the shape of the acquisition box in the first display state, and the ratio of the area of the tracking box to the area of the acquisition box in the first display state is greater than or equal to the ratio threshold, the acquisition box in the first display state is switched to the acquisition box in the second display state to be displayed.

Accordingly, embodiments of this disclosure provide a method for acquiring the palm print. Since the tracking box changes with the change in the pose of the palm region in the real space, the user can be guided to adjust the pose of the palm region by guiding the user to adjust the tracking box. Further, by guiding the user to adjust the tracking box to satisfy the matching condition with the acquisition box in the first display state, blind adjustment by the user may be reduced, and efficiency of palm print acquisition by the user can be improved.

According to the method provided by the embodiments of this disclosure, the tracking box is further displayed by taking the reference point on the screen region corresponding to the palm region as the center point of the tracking box. Thus, the tracking box always changes based on the change in the palm region. The tracking box can be adjusted in time when the palm region changes dynamically. For example, the tracking box can be updated in time when the palm region undergoes the inclination, translation, or rotation following the palm. Thus, real-time guidance is provided for the user.

According to the method provided by the embodiments of this disclosure, the tracking box is further displayed by taking the first size as the size of the tracking box. Thus, the size of the tracking box is determined according to the distance between the palm region and the camera. The size of the tracking box can be dynamically adjusted, such that real-time guidance is provided for the user.

According to the method provided by the embodiments of this disclosure, the tracking box is further displayed by taking the first aspect ratio as an aspect ratio of the tracking box. Thus, the aspect ratio of the tracking box is determined according to the included angle between the plane where the palm region is located and the plane where the terminal screen is located. The aspect ratio of the tracking box can be dynamically adjusted, such that real-time guidance is provided for the user.

Before operation 2040, the method further includes the following operations:

Operation 3020: Obtain, in response to determining that a detected object is recognized in the camera preview screen, an image frame corresponding to the detected object.

The detected object is a skin region in some embodiments. In some embodiments, the detected object is the palm or the detected object is not the palm. In some embodiments, in response to determining that the palm is recognized in the camera preview screen, an image frame corresponding to the palm is obtained. Alternatively, in response to determining that an object other than the palm is recognized in the camera preview screen, an image frame corresponding to the recognized object is obtained.

In some embodiments, the image frame is a preprocessed image frame. In some embodiments, a preprocessing operation includes at least one of color space conversion, binarization, filtering, or edge detection. In some embodiments, the image frame is an unpreprocessed image frame. The preprocessing operation is configured to reduce noise and background interference in the image frame, and a feature in the image frame is highlighted.

In some embodiments, it is determined whether the detected object is the palm based on the obtained image frame. For example, the method further includes the following operations:

Operation 3031: Extract a skin region from the image frame, and extract a contour of the skin region.

In some embodiments, the skin region in the image frame is extracted based on a color threshold. In some embodiments, the image frame is converted from a first color space to a second color space, and information about colors in the first color space and information about colors in the second color space are different. For example, the first color space is a red green blue (RGB) color space, and the second color space is a hue saturation value (HSV) color space.

In some embodiments, the color threshold is preset. The color threshold is configured to distinguish a skin region from a non-skin region in the image frame. In some embodiments, in a case that a color difference between the skin region and the non-skin region in the image frame is significant, the skin region in the image frame is directly extracted. In some embodiments, in a case that a color difference between the skin region and the non-skin region in the image frame is insignificant, the image frame is converted from the first color space to the second color space, the color difference between the skin region and the non-skin region in the image frame is highlighted, and the skin region is extracted from the image frame.

In some embodiments, the contour of the skin region is extracted through an edge detection algorithm. In some embodiments, the contour of the skin region is extracted through a Canny algorithm. In some embodiments, the contour of the skin region is extracted by a Sobel algorithm. In some embodiments, the Canny algorithm is a standard algorithm widely applied to edge detection, and aims at finding an optimal edge detection solution or finding a position with a strongest gray scale intensity change in an image. An optimal edge detection is used for evaluation through three criteria of a low error rate, high localization, and minimum response. In some embodiments, the Sobel algorithm is used for the edge detection. Technically, an approximate value of a gray scale of an image brightness function is calculated through a set of discrete difference operators.

In some embodiments, whether the detected object is the palm is determined according to the contour of the skin region.

Operation 3032: Determine that the detected object is the palm in a case that the contour of the skin region corresponds to a contour of the palm.

In some embodiments, the contour of the skin region is compared with the contour of the palm, and it is determined that the detected object is the palm in a case that the contour of the skin region corresponds to the contour of the palm. In a case that the contour of the skin region does not correspond to the contour of the palm, it is determined that the detected object is not the palm.

In some embodiments, the contour of the palm corresponds to features such as a shape, an area, and a perimeter. In some embodiments, it is determined whether the detected object is the palm by comparing the shape of the contour of the skin region with the shape of the contour of the palm. In some embodiments, mapping exists between the features of the contour of the palm. For example, in a case that a corresponding area of the contour of the palm is 10 square centimeters, a corresponding perimeter is 15 centimeters. In a case that a corresponding area of the contour of the palm is 20 square centimeters, a corresponding perimeter is 30 centimeters.

In some embodiments, in a case that it is determined that the detected object is the palm, operation 3040 below is continuously performed. In a case that it is determined that the detected object is not the palm, the above operations are repeated until it is determined that the detected object is the palm.

Operation 3040: Extract a palm feature point from the image frame and determine the palm region based on the palm feature point in a case that it is determined that the detected object is the palm.

In some embodiments, in a case that it is determined that the detected object is the palm, the palm feature points are extracted from the image frame. In some embodiments, the palm feature points include a palm convex point and a palm concave point.

In some embodiments, the palm convex point refers to a feature point corresponding to a relative convex position in the palm, such as a fingertip position. The palm concave point refers to a feature point corresponding to a relative concave position in the palm, such as a knuckle position. In some embodiments, with the first body part being the palm as an example, positions where the palm convex points are located include the fingertip position, a center position of the knuckle, and a center position of a finger base joint. Positions where the palm concave points are located include a knuckle position, a finger base position, and a center position of the palm.

In some embodiments, the palm region is determined based on the palm feature points. The palm region is a region other than fingers in the palm, or the palm region is a region including the palm print features. In some embodiments, a boundary line between the fingers and the palm region is determined based on the palm feature point. Based on the boundary line and the contour of the palm, the palm region is determined.

In summary, according to the method provided by the embodiments of this disclosure, the image frame corresponding to the detected object is obtained in response to determining that the detected object is recognized in the camera preview screen. The skin region in the image frame, and the contour corresponding to the skin region are extracted, and whether the detected object is the palm is determined. Thus, the method provided by the embodiments of this disclosure can accurately acquire the palm print. In a case that the detected object is not the palm, repeated recognition is needed instead of an invalid operation of extracting the palm feature point. Thus, the invalid operation in a case that the detected object is not the palm can be reduced, and accuracy of palm print acquisition can be improved.

In some embodiments, in the process of the palm print acquisition, the terminal notifies the user through at least one piece of notification information. In some embodiments, the notification information includes at least one of the following:
first notification information;
second notification information; and
third notification information.

In some embodiments, the first notification information is configured to notify adjustment to the position of the palm. For example, the method further includes the following operations:

Operation 4020: Display the first notification information in a case that it is determined that the detected object is the palm, and the contour of the palm is incomplete.

Operation 4020 is performed after operation 3032. In an example, in a case that the detected object is determined to be the palm, whether the contour of the palm is complete is determined by analyzing the contour of the palm. In some embodiments, whether the contour of the palm is interrupted is determined by calculating a ratio of the area to the perimeter of the contour of the palm. For example, in a case that the contour of the palm is uninterrupted, the ratio of the area to the perimeter of the contour of the palm is 1:1.5. Then, the contour of the palm can be determined to be interrupted in a case that the calculated ratio of the area to the perimeter of the contour of the palm is 1:1.

In some embodiments, in a case that the contour of the palm is incomplete, the palm region may not be accurately recognized. For example, in a case that the contour of the palm merely includes a contour of fingers, the palm region may not be recognized. Thus, the first notification information is displayed in a case that the detected object is determined to be the palm and the contour of the palm is incomplete. The user is reminded to adjust the position of the palm through the first notification information. Thus, the complete contour of the palm can be recognized, and the palm region can be more accurately recognized.

For example, as shown in FIG. 12, in a case that it is determined that the detected object is the palm, and the contour of the palm is incomplete, the first notification information 18 is displayed. The first notification information 18 is configured to notify the user to notice that “the palm is incomplete”.

In some embodiments, the second notification information is configured to notify to replace the detected object. For example, the method further includes the following operations:

Operation 5020: Display the second notification information in a case that it is determined that the detected object is not the palm.

In some embodiments, after operation 3031, in a case that it is determined that the detected object is not the palm, the second notification information is displayed. Alternatively, in response to determining that the recognized detected object is a target object, and the target object is not the palm, the second notification information is displayed.

For example, as shown in FIG. 14, in a case that it is determined that the detected object is not the palm, and the second notification information 19 is displayed. The second notification information 19 is configured to notify the user to notice that “the palm is not recognized”.

In some embodiments, in a case that it is repeatedly determined that the detected object is not the palm, the second notification information is repeatedly displayed until the user replaces the detected object with the palm.

In some embodiments, the third notification information is configured to notify to adjust light of the image frame. For example, the method further includes the following operations:

Operation 6020: Extract a light feature from the image frame.

In some embodiments, after operation 3020, for example, after the image frame of the detected object is obtained, the light features in the image frame are extracted. In some embodiments, the light features include brightness and chroma. In some embodiments, the brightness of the light in the image frame is extracted. In some embodiments, the chroma of the light in the image frame is extracted.

Operation 6040: Display the third notification information in a case that the light feature does not satisfy a light feature threshold.

In some embodiments, the extracted light feature is compared with the light feature threshold, and in a case that the light feature indicates that the light in the image frame satisfies the light feature threshold, it is determined that the light in the image frame satisfies the condition, and operation 3031 is continuously performed. In a case that the light feature indicates that the light in the image frame does not satisfy the light feature threshold, it is determined that the light in the image frame does not satisfy the condition, and the third notification information is displayed. In some embodiments, the light feature threshold is preset or dynamically adjusted. The third notification information is configured to notify to adjust an illumination condition of the real space under which the image frame is taken.

For example, as shown in FIG. 16, in a case that the light feature in the image frame does not satisfy the light feature threshold, or in a case that the light in the obtained acquired image 51 is less or dim, the third notification information 50 is displayed. The third notification information 50 is configured to notify the user to notice that “the light is dim”, or to notify the user to adjust light in current acquisition environment.

According to the method provided by the embodiments of this disclosure, the user is notified by displaying at least one piece of notification information. Thus, the user can be reminded to perform adjustment according to various situations in the process of the palm print acquisition in time, and the process of the palm print acquisition can proceed more smoothly.

In some embodiments, by taking a face acquisition process as an example, the method includes the following operations:

Operation 20020: Display a camera preview screen and an acquisition box in a first display state in a process of face feature acquisition.

In some embodiments, the camera preview screen and the acquisition box in the first display state are displayed in response to a trigger operation on a face feature acquisition client. The trigger operation includes at least one of single click, double click, left-right slide, up-down slide, long press, hover, face recognition, or voice recognition. The trigger operation includes, but is not limited to, the types described above. Those of ordinary skill in the art are to be able to know that any operation that can implement the functions described above falls within the scope of this disclosure.

In some embodiments, the camera preview screen and the acquisition box in the first display state are displayed simultaneously. In some embodiments, the camera preview screen and the acquisition box in the first display state are not displayed simultaneously. In some embodiments, the acquisition box in the first display state is displayed after the camera preview screen is displayed. For example, the camera preview screen is displayed at first, and then the acquisition box in the first display state is displayed after a detected object is recognized. In some embodiments, the camera preview screen is displayed after the acquisition box in the first display state is displayed.

In some embodiments, the camera preview screen is a screen shot by a camera in real time. In some embodiments, the camera preview screen is displayed in full screen on a terminal screen. In some embodiments, the camera preview screen is displayed in a target region on the terminal screen. The target region is preset or the target region is dynamically changed. For example, the target region is a one-third region in a middle of the terminal screen. In an aspect of this disclosure, description is made by taking the camera preview screen being displayed in full screen on the terminal screen as an example.

In some embodiments, the acquisition box in the first display state is determined based on device parameters related to the terminal. For example, the device parameters include camera parameters and picture imaging parameters. The camera parameters include at least one of resolution, a focal length, a field of view, distortion, chromatic aberration, or sharpness. The picture imaging parameters are determined based on pictures actually shot by the terminal. In some embodiments, as shown in FIG. 3, the device parameters of different devices are acquired in advance, and then different devices are classified based on the device parameters, such as class A, class B, class C, and class D. Each class corresponds to acquisition box parameters, and the acquisition box parameters include at least one of a display size, a display position, or a display form that are configured to indicate that the acquisition box is displayed on a face feature enrollment interface. The acquisition box parameters are stored in the server 120. In some embodiments, when starting the acquisition of the face feature, the terminal 110 transmits a request to invoke the acquisition box parameters to the server 120. The server 120 transmits corresponding acquisition box parameters to the terminal 110 according to a class to which the terminal 110 belongs. The terminal 110 displays the acquisition box in the first display state based on the acquisition box parameters received.

In some embodiments, a display shape of the acquisition box in the first display state is preset or dynamically changed. For example, at least two display shapes of the acquisition box in the first display state are provided for being selected, including at least two of a circle, a square, and a trapezoid. A preset display shape of the acquisition box in the first display state is the circle, and a user may alternatively choose to modify the display shape of the acquisition box in the first display state to the square. In some embodiments, the display size of the acquisition box in the first display state is preset or dynamically changed. For example, the display size of the acquisition box in the first display state is one third of the terminal screen. In some embodiments, the display position of the acquisition box in the first display state is preset or dynamically changed. For example, the acquisition box in the first display state is displayed in a center position of the terminal screen.

In some embodiments, the first display state is configured to being distinguished from a second display state. The first display state is different from the second display state. In some embodiments, the first display state is a first color, such as black. The second display state is a second color, or a color other than the first color, such as green. In some embodiments, the first display state is a first display entity, such as a solid line. The second display state is a second display entity, or a display entity other than the first display entity, such as a dotted line.

For example, as shown in FIG. 2, the camera preview screen 11 and the acquisition box 12 in the first display state are displayed in the process of the face feature acquisition.

Operation 20040: Display, in response to determining that a face region is recognized in the camera preview screen, a tracking box on a screen region corresponding to the face region.

In some embodiments, in response to determining that the face region is recognized in the camera preview screen, the tracking box is Up displayed on the screen region corresponding to the face region. The tracking box follows the face region. The tracking box is configured to box the face region in the camera preview screen, and the display shape, the display size, and the display position of the tracking box change following the face region.

In some embodiments, a display state of the tracking box is preset. In some embodiments, the display state of the tracking box is the first display state. In some examples, the display state of the tracking box is the same as a start display state of the acquisition box. In some embodiments, the display state of the tracking box is the second display state. In some examples, the display state of the tracking box is the same as a final display state of the acquisition box. In some embodiments, the display state of the tracking box is the same as a display state of the acquisition box. In some examples, when the acquisition box is in the first display state, the tracking box is also in the same first display state. When a relative position between the tracking box and the acquisition box in the first display state satisfies a matching condition, the first display state is switched to the second display state to be displayed. In some embodiments, the display state of the tracking box is a third display state. In some examples, the display state of the tracking box is different from the display state of the acquisition box. For example, in a case that the first display state of the acquisition box is red, and the second display state of the acquisition box is green, the display state of the tracking box is yellow.

In some embodiments, the display state of the tracking box is dynamically changed. In some embodiments, the display state of the tracking box changes with a change in a distance between the face region and the camera. In some embodiments, the greater the distance between the face region and the camera is, the greater a difference between the display state of the tracking box and the display state of the acquisition box is. The smaller the distance between the face region and the camera is, the smaller a difference between the display state of the tracking box and the display state of the acquisition box is. For example, assuming that the first display state of the acquisition box is red, the display state of the tracking box changes from a color close to red to a color greatly different from red (such as yellow) when the face region gets far away from the camera from a position close to the camera.

In some embodiments, the tracking box corresponds to a tracking sound. The tracking sound and the tracking box exist synchronously, and the tracking sound is played in linkage with display of the tracking box. In some embodiments, the tracking sound is preset. For example, the tracking sound corresponds to the display state of the tracking box, and the tracking sound is also fixed in a case that the display state of the tracking box is fixed. In some embodiments, the tracking sound and the tracking box are in one-to-one mapping.

In some embodiments, the tracking sound is dynamically changed. For example, the tracking sound changes with the change in the tracking box. In some embodiments, urgency of the tracking sound changes with the change in the distance between the face region and the camera. The urgency of the tracking sound has a negative correlation with the distance between the face region and the camera. In a case that the face region gets closer to the camera, the tracking sound becomes increasingly urgent. In a case that the face region gets farther away from the camera, the tracking sound becomes increasingly gentle. In some embodiments, a tone of the tracking sound changes with the change in the distance between the face region and the camera. The tone of the tracking sound has a negative correlation with the distance between the face region and the camera. In a case that the face region gets closer to the camera, the tone becomes increasingly high. In a case that the face region gets farther away from the camera, the tracking sound becomes increasingly low.

In some embodiments, an effect mask is displayed while the tracking box is displayed. The effect mask is attached to the face region. The effect mask is configured to notify the user to notice that the tracking box is displayed, and can improve interest in guiding the user through an effect. In some embodiments, the effect mask is preset. For example, the feature mask is a facial sticker. In some embodiments, the effect mask is dynamically changed. In some embodiments, a display effect of the effect mask may change following the change in the distance between the face region and the camera. For example, the effect mask is the facial sticker. In a case that the face region moves away from the camera, the facial sticker is displayed smaller. In a case that the face region moves close to the camera, the facial sticker is displayed larger.

In some embodiments, the tracking box changes with a change in a pose of the face region in a real space. In some embodiments, the display shape of the tracking box changes with a change in a plane where the face region is located and the change in the distance between the face region and the camera.

In some embodiments, in response to determining that the face region is recognized in the camera preview screen, first aspect ratio is taken as aspect ratio of the tracking box, and the tracking box is displayed on the screen region corresponding to the face region. The first aspect ratio is associated with an included angle between a plane where the face region is located and a plane where a terminal screen is located. In some embodiments, the first aspect ratio has a positive correlation with the included angle between the plane where the face region is located and the plane where the terminal screen is located.

For example, if the included angle between the plane where the face region is located and the plane where the terminal screen is located is zero in the real space, the tracking box in a standard state is displayed. The standard state is a circular box. If the included angle between the plane where the face region is located and the plane where the terminal screen is located is gradually increased, an elliptical box is displayed. The elliptical box has a higher aspect ratio as the included angle is gradually increased. If the included angle between the plane where the face region is located and the plane where the terminal screen is located is gradually reduced, the displayed elliptical box becomes closer to the circular box. In some embodiments, the tracking box is configured to track a projection of a feature box of the face region in the camera preview screen. The feature box is configured to box the face region on the plane where the face region is located.

In some embodiments, a shape of the feature box is the same as a shape of the acquisition box in the first display state. For example, if the shape of the acquisition box in the first display state is circular, the shape of the feature box is also circular.

In some embodiments, in response to determining that the face region is recognized, a reference point on the screen region corresponding to the face region is taken as a center point of the tracking box, and the tracking box is displayed. In some embodiments, the reference point is a center point on the face region.

In some embodiments, in response to determining that the face region is recognized in the camera preview screen, a first size is taken as a size of the tracking box, and the tracking box is displayed on the screen region corresponding to the body feature region. The first size is associated with the distance between the face region and the camera. In some embodiments, the first size has a negative correlation with the distance between the face region and the camera. In some embodiments, the farther the distance between the face region and the camera is, the smaller the first size is. The closer the distance between the face region and the camera is, the larger the first size is. For example, as shown in FIG. 5 and FIG. 7, when the face region moves from a position closer to the camera to a position farther away from the camera, the size of the tracking box 13 is also reduced from one first size to another first size.

In some embodiments, display of the tracking box is updated in response to at least one of inclination, translation, or rotation of the face region following a head, to keep the center point of the tracking box consistent with the reference point on the screen region corresponding to the face region. A center point of the updated tracking box coincides with the reference point on the screen region corresponding to the face region. In some embodiments, the display of the tracking box is updated in response to the inclination of the face region following the head. In some embodiments, the display of the tracking box is updated in response to the translation of the face region following the head. In some embodiments, the display of the tracking box is updated in response to the rotation of the face region following the head.

In some embodiments, the reference point is a specified point on the screen region corresponding to the face region. In some embodiments, the reference point may be at least one of a center point, an upper edge point, a lower edge point, a left edge point, or a right edge point on a screen region corresponding to the face region.

Operation 20060: Determine that the pose of the face region in the real space reaches the acquisition pose in response to determining that the tracking box and the acquisition box in the first display state satisfy a matching condition.

In an aspect of this disclosure, the acquisition box in the first display state and the tracking box are displayed on the camera preview screen, and the tracking box changes with the change in the pose of the face region of the user in the real space. In a dynamic change process of the tracking box, if the tracking box matches the acquisition box in the first display state, the pose of the face region in the real space is determined to reach the acquisition pose. The acquisition pose refers to a pose that the face region is required to be in when the identity feature of the face region is acquired. In the acquisition pose, the terminal device can acquire high-quality, clear, and complete identity features.

In some embodiments, in response to determining that the tracking box and the acquisition box in the first display state satisfy the matching condition, the acquisition box in the first display state is switched to an acquisition box in a second display state to be displayed, the acquisition box in the second display state being configured to indicate that the pose of the face region in the real space reaches the acquisition pose. The first display state is different from the second display state.

The acquisition box in the second display state refers to a result box in a matching process. If the acquisition box in the first display state and the tracking box satisfy the matching condition, the acquisition box in the first display state is switched to the acquisition box in the second display state to be displayed. The first display state and the second display state are different display states. A case that the acquisition box in the first display state is switched to the acquisition box in the second display state to be displayed indicates that a pose of a current face region in the real space reaches the acquisition pose. In some examples, the pose of the current face region in the real space satisfies a condition. In this case, the face region may be subjected to feature acquisition.

In some embodiments, the matching condition includes at least one of the following:
a shape of the tracking box is the same as a shape of the acquisition box in the first display state;
the size of the tracking box is the same as a size of the acquisition box in the first display state;
a ratio of an area of the tracking box to an area of the acquisition box in the first display state is greater than or equal to a ratio threshold;
an overlapped area between the tracking box and the acquisition box in the first display state is greater than or equal to an area threshold;
a distance between a center of the tracking box and a center of the acquisition box in the first display state is less than a distance threshold;
a difference between a radius of the tracking box and a radius of the acquisition box in the first display state is less than a length difference threshold; and
an included angle between a plane where the tracking box is located and a plane where the acquisition box is located in the first display state is less than an angle difference threshold.

In some embodiments, in response to determining that the shape of the tracking box is the same as the shape of the acquisition box in the first display state, the acquisition box in the first display state is switched to the acquisition box in the second display state to be displayed. The tracking box is the projection of the feature box in the camera preview screen. Thus, when the plane where the face region is located is parallel to the plane where the terminal screen is located, the shape of the tracking box is the same as the shape of the acquisition box in the first display state. In this case, the acquisition box in the first display state is switched to the acquisition box in the second display state to be displayed.

In some embodiments, in response to determining that the size of the tracking box is the same as the size of the acquisition box in the first display state, the acquisition box in the first display state is switched to the acquisition box in the second display state to be displayed. The size of the tracking box herein may be understood as an area size of the tracking box. In some examples, in response to determining that an area size of the tracking box is the same as an area size of the acquisition box in the first display state, the acquisition box in the first display state is switched to the acquisition box in the second display state to be displayed. Alternatively, the size of the tracking box herein may alternatively be understood as the size of the tracking box in a case that the shape of the tracking box is the same as the shape of the acquisition box in the first display state. In some examples, in response to determining that the shape of the tracking box is the same as the shape of the acquisition box in the first display state, and the size of the tracking box is the same as the size of the acquisition box in the first display state, the acquisition box in the first display state is switched to the acquisition box in the second display state to be displayed.

In some embodiments, in response to determining that the ratio of the area of the tracking box to the area of the acquisition box in the first display state is greater than or equal to the ratio threshold, the acquisition box in the first display state is switched to the acquisition box in the second display state to be displayed. The area of the acquisition box in the first display state remains unchanged after the acquisition box in the first display state is displayed. The area of the tracking box changes with update of the tracking box. In some embodiments, the ratio threshold is preset or dynamically changed. For example, if the ratio threshold is four fifths, the acquisition box in the first display state is switched to the acquisition box in the second display state to be displayed in response to determining that the ratio of the area of the tracking box to the area of the acquisition box in the first display state is greater than or equal to four fifths.

In some embodiments, in response to determining that the overlapped area between the tracking box and the acquisition box in the first display state is greater than or equal to the area threshold, the acquisition box in the first display state is switched to the acquisition box in the second display state to be displayed. In some embodiments, the area threshold is preset or dynamically changed. For example, the area threshold is 2 square centimeters. For example, as shown in FIG. 8, in response to determining that the area of an overlapped region 16 between the tracking box 13 and the acquisition box 12 in the first display state is greater than or equal to 2 square centimeters, the acquisition box 12 in the first display state is switched to the acquisition box in the second display state to be displayed.

In some embodiments, in response to determining that the distance between the center of the tracking box and the center of the acquisition box in the first display state is less than the distance threshold, the acquisition box in the first display state is switched to the acquisition box in the second display state to be displayed. In some embodiments, the distance threshold is preset or dynamically changed. For example, the distance threshold is 2 centimeters. For example, as shown in FIG. 8, in response to determining that the distance 17 between the center of the tracking box 13 and the center of the acquisition box 12 in the first display state is less than 2 centimeters, the acquisition box 12 in the first display state is switched to the acquisition box in the second display state to be displayed.

In some embodiments, in a case that the acquisition box in the first display state is circular and the tracking box is circular, in response to determining that the difference between the radius of the tracking box and the radius of the acquisition box in the first display state is less than the length difference threshold, the acquisition box in the first display state is switched to the acquisition box in the second display state to be displayed. In some embodiments, the length difference threshold is preset or dynamically changed. For example, the length difference threshold is 1 centimeter. In response to determining that the difference between the radius of the tracking box and the radius of the acquisition box in the first display state is less than 1 centimeter, the acquisition box in the first display state is switched to the acquisition box in the second display state to be displayed. In a case that the acquisition box in the first display state is circular and the tracking box is circular, for example, the shape of the acquisition box in the first display state is the same as the shape of the tracking box, and the plane where the face region is located is parallel to the plane where the terminal screen is located.

In some embodiments, in response to determining that the included angle between the plane where the face region is located and the plane where the acquisition box in the first display state is located is less than the angle difference threshold, the acquisition box in the first display state is switched to the acquisition box in the second display state to be displayed. Alternatively, in response to determining that the included angle between the plane where the feature box is located and the plane where the terminal screen is located is less than the angle difference threshold, the acquisition box in the first display state is switched to the acquisition box in the second display state to be displayed. The tracking box is the projection of the feature box on the plane where the terminal screen is located. In some embodiments, the angle difference threshold is preset or dynamically changed. For example, the angle difference threshold is 30 degrees. In response to determining that the included angle between the plane where the face region is located and the plane where the acquisition box in the first display state is located is less than 30 degrees, the acquisition box in the first display state is switched to the acquisition box in the second display state to be displayed.

In some embodiments, the matching condition may be a combination of n conditions described above, and n is an integer greater than 1. For example, the matching condition includes that the shape of the tracking box is the same as the shape of the acquisition box in the first display state, and the ratio of the area of the tracking box to the area of the acquisition box in the first display state is greater than or equal to the ratio threshold. Then, in response to determining that the shape of the tracking box is the same as the shape of the acquisition box in the first display state, and the ratio of the area of the tracking box to the area of the acquisition box in the first display state is greater than or equal to the ratio threshold, the acquisition box in the first display state is switched to the acquisition box in the second display state to be displayed.

Accordingly, embodiments of this disclosure provide a method for acquiring the face feature. Since the display position of the tracking box changes with the change in the pose of the face region in the real space, the user can be guided to adjust the pose of the face region by guiding the user to adjust the tracking box. Further, by guiding the user to adjust the tracking box to a position where a relative position between the tracking box and the acquisition box in the first display state satisfies the matching condition, blind adjustment by the user may be reduced, and efficiency of face feature acquisition by the user can be improved.

According to the method provided by the embodiments of this disclosure, the tracking box is further displayed by taking the reference point on the screen region corresponding to the face region as the center point of the tracking box. Thus, the tracking box always changes based on the change in the face region. The tracking box can be adjusted in time when the face region changes dynamically. For example, the tracking box can be updated in time when the face region undergoes the inclination, translation, or rotation following the head. Thus, real-time guidance is provided for the user.

According to the method provided by the embodiments of this disclosure, the tracking box is further displayed by taking the first size as the size of the tracking box. Thus, the size of the tracking box is determined according to the distance between the face region and the camera. The size of the tracking box can be dynamically adjusted, such that real-time guidance is provided for the user.

According to the method provided by the embodiments of this disclosure, the tracking box is further displayed by taking the first aspect ratio as an aspect ratio of the tracking box. Thus, the aspect ratio of the tracking box is determined according to the included angle between the plane where the face region is located and the plane where the terminal screen is located. The aspect ratio of the tracking box can be dynamically adjusted, such that real-time guidance is provided for the user.

Before operation 20040, the method further includes the following operations:

Operation 30020: Obtain, in response to determining that a detected object is recognized in the camera preview screen, an image frame corresponding to the detected object.

The detected object is a skin region in some embodiments. In some embodiments, the detected object is the head or the detected object is not the head. In some embodiments, in response to determining that the head is recognized in the camera preview screen, an image frame corresponding to the head is obtained. Alternatively, in response to determining that an object other than the head is recognized in the camera preview screen, an image frame corresponding to the recognized object is obtained.

In some embodiments, the image frame is a preprocessed image frame. In some embodiments, a preprocessing operation includes at least one of color space conversion, binarization, filtering, or edge detection. In some embodiments, the image frame is an unpreprocessed image frame. The preprocessing operation is configured to help reduce noise and background interference in the image frame, and a feature in the image frame is highlighted.

In some embodiments, it is determined whether the detected object is the head based on the obtained image frame. For example, the method further includes the following operations:

Operation 30031: Extract a skin region from the image frame, and extract a contour of the skin region.

In some embodiments, the skin region in the image frame is extracted based on a color threshold. In some embodiments, the image frame is converted from a first color space to a second color space, and information about colors in the first color space and information about colors in the second color space are different. For example, the first color space is a red green blue (RGB) color space, and the second color space is a hue saturation value (HSV) color space.

In some embodiments, the color threshold is preset. The color threshold is configured to distinguish a skin region from a non-skin region in the image frame. In some embodiments, in a case that a color difference between the skin region and the non-skin region in the image frame is significant, the skin region in the image frame is directly extracted. In some embodiments, in a case that a color difference between the skin region and the non-skin region in the image frame is insignificant, the image frame is converted from the first color space to the second color space, the color difference between the skin region and the non-skin region in the image frame is highlighted, and the skin region is extracted from the image frame.

In some embodiments, the contour of the skin region is extracted through an edge detection algorithm. In some embodiments, the contour of the skin region is extracted through a Canny algorithm. In some embodiments, the contour of the skin region is extracted by a Sobel algorithm. In some embodiments, the Canny algorithm is a standard algorithm widely applied to edge detection, and aims at finding an optimal edge detection solution or finding a position with a strongest gray scale intensity change in an image. An optimal edge detection is used for evaluation through three criteria of a low error rate, high localization, and minimum response. In some embodiments, the Sobel algorithm is used for the edge detection. Technically, an approximate value of a gray scale of an image brightness function is calculated through a set of discrete difference operators.

In some embodiments, whether the detected object is the head is determined according to the contour of the skin region.

Operation 30032: Determine that the detected object is the head in a case that the contour of the skin region corresponds to a contour of the head.

In some embodiments, the contour of the skin region is compared with the contour of the head, and it is determined that the detected object is the head in a case that the contour of the skin region corresponds to the contour of the head. In a case that the contour of the skin region does not correspond to the contour of the head, it is determined that the detected object is not the head.

In some embodiments, the contour of the head corresponds to features such as a shape, an area, and a perimeter. In some embodiments, it is determined whether the detected object is the head by comparing the shape of the contour of the skin region with the shape of the contour of the head. In some embodiments, mapping exists between the features of the contour of the head. For example, in a case that a corresponding area of the contour of the head is 10 square centimeters, a corresponding perimeter is 15 centimeters. In a case that a corresponding area of the contour of the head is 20 square centimeters, a corresponding perimeter is 30 centimeters.

In some embodiments, in a case that it is determined that the detected object is the head, operation 30040 below is continuously performed. In a case that it is determined that the detected object is not the head, the above operations are repeated until it is determined that the detected object is the head.

Operation 30040: Extract a head feature point from the image frame and determine the face region based on the head feature point in a case that it is determined that the detected object is the head.

In some embodiments, in a case that it is determined that the detected object is the head, the head feature points are extracted from the image frame. In some embodiments, the head feature points include a head convex point and a head concave point.

In some embodiments, the head convex point refers to a feature point corresponding to a relative convex position in the head, such as nose tip position. The head concave point refers to a feature point corresponding to a relative concave position in the head, such as an eye position. In some embodiments, with the first body part being the head as an example, positions where the head convex points are located include the nose tip position, a center position of an eye, and a center position of an eyebrow. Positions where the head concave points are located include an eye corner position, a nose edge position, and a center position of a mouth.

In some embodiments, the face region is determined based on the head feature points. The face region is a region other than hairs or forehead in the head, or the face region is a region including the face features. In some embodiments, a boundary line between the hairs or forehead and the face region is determined based on the head feature point. Based on the boundary line and the contour of the head, the face region is determined.

Accordingly, based on one or more methods provided in this disclosure, the image frame corresponding to the detected object is obtained in response to determining that the detected object is recognized in the camera preview screen. The skin region in the image frame, and the contour corresponding to the skin region are extracted, and whether the detected object is the head is determined. Thus, the method provided by the embodiments of this disclosure can accurately acquire the face feature. In a case that the detected object is not the head, repeated recognition is needed instead of an invalid operation of extracting the head feature point. Thus, the invalid operation in a case that the detected object is not the head can be reduced, and accuracy of face feature acquisition can be improved.

In some embodiments, in the process of the face feature acquisition, the terminal notifies the user through at least one piece of notification information. In some embodiments, the notification information includes at least one of the following:
first notification information;
second notification information; and
third notification information.

In some embodiments, the first notification information is configured to notify adjustment to the position of the head. For example, the method further includes the following operations:

Operation 40020: Display the first notification information in a case that it is determined that the detected object is the head, and the contour of the head is incomplete.

Operation 40020 is performed after operation 30032. In an example, in a case that the detected object is determined to be the head, whether the contour of the head is complete is determined by analyzing the contour of the head. In some embodiments, whether the contour of the head is interrupted is determined by calculating a ratio of the area to the perimeter of the contour of the head. For example, in a case that the contour of the head is uninterrupted, the ratio of the area to the perimeter of the contour of the head is 1:1.5. Then, the contour of the head can be determined to be interrupted in a case that the calculated ratio of the area to the perimeter of the contour of the head is 1:1.

In some embodiments, in a case that the contour of the head is incomplete, the face region may not be accurately recognized. For example, in a case that the contour of the head merely includes a contour of a temple area, the face region may not be recognized. Thus, the first notification information is displayed in a case that the detected object is determined to be the head and the contour of the head is incomplete. The user is reminded to adjust the position of the head through the first notification information. Thus, the complete contour of the head can be recognized, and the face region can be more accurately recognized.

For example, as shown in FIG. 12, in a case that it is determined that the detected object is the head, and the contour of the head is incomplete, the first notification information 18 is displayed. The first notification information 18 is configured to notify the user to notice that “the head is incomplete”.

In some embodiments, the second notification information is configured to notify to replace the detected object. For example, the method further includes the following operations:

Operation 50020: Display the second notification information in a case that it is determined that the detected object is not the head.

In some embodiments, after operation 30031, in a case that it is determined that the detected object is not the head, the second notification information is displayed. Alternatively, in response to determining that the recognized detected object is a target object, and the target object is not the head, the second notification information is displayed.

For example, as shown in FIG. 14, in a case that it is determined that the detected object is not the head, and the second notification information 19 is displayed. The second notification information 19 is configured to notify the user to notice that “the head is not recognized”.

In some embodiments, in a case that it is repeatedly determined that the detected object is not the head, the second notification information is repeatedly displayed until the user replaces the detected object with the head.

In some embodiments, the third notification information is configured to notify to adjust light of the image frame. For example, the method further includes the following operations:

Operation 60020: Extract a light feature from the image frame.

In some embodiments, after operation 30020, for example, after the image frame of the detected object is obtained, the light features in the image frame are extracted. In some embodiments, the light features include brightness and chroma. In some embodiments, the brightness of the light in the image frame is extracted. In some embodiments, the chroma of the light in the image frame is extracted.

Operation 60040: Display the third notification information in a case that the light feature does not satisfy a light feature threshold.

In some embodiments, the extracted light feature is compared with the light feature threshold, and in a case that the light feature satisfies the light feature threshold, it is determined that the light in the image frame satisfies the condition, and operation 30031 is continuously performed. In a case that the light feature does not satisfy the light feature threshold, it is determined that the light in the image frame does not satisfy the condition, and the third notification information is displayed. In some embodiments, the light feature threshold is preset or dynamically adjusted. The third notification information is configured to notify to adjust an illumination condition of the real space under which the image frame is taken.

For example, as shown in FIG. 16, in a case that the light feature in the image frame does not satisfy the light feature threshold, or in a case that the light in the obtained acquired image 51 is less or dim, the third notification information 50 is displayed. The third notification information 50 is configured to notify the user to notice that “the light is dim”, or to notify the user to adjust light in current acquisition environment.

According to the method provided by the embodiments of this disclosure, the user is notified by displaying at least one piece of notification information. Thus, the user can be reminded to perform adjustment according to various situations in the process of the face feature acquisition in time, and the process of the face feature acquisition can proceed more smoothly.

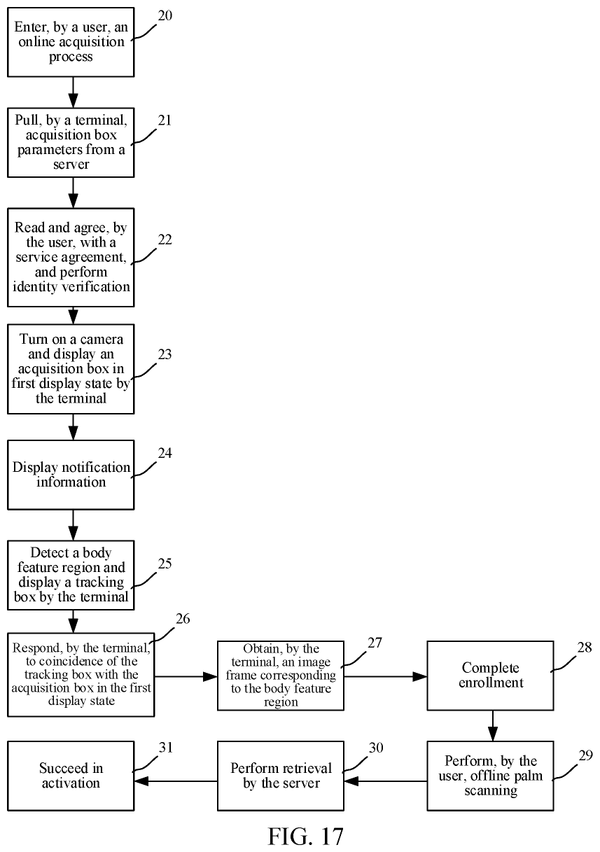

According to the method for determining an acquisition pose provided by the embodiments of this disclosure, the user can be intuitively and efficiently guided to enroll the first body part, and see a state of a current first body part as well as an optimal enrollment pose and distance in real time. Thus, an enrollment success rate is increased. In an example, as shown in FIG. 17, the method includes the following operations:

Operation 20: A user enters an online acquisition process.

The user clicks or long presses and opens the identity feature acquisition client, to start identity feature acquisition.

Operation 21: A terminal pulls acquisition box parameters from a server.

The acquisition box parameters include at least one of a display size, a display position, or a display form that are configured to indicate that the acquisition box is displayed on an identity feature enrollment interface.

Operation 22: The user reads and agrees with a service agreement, and is subjected to identity verification.

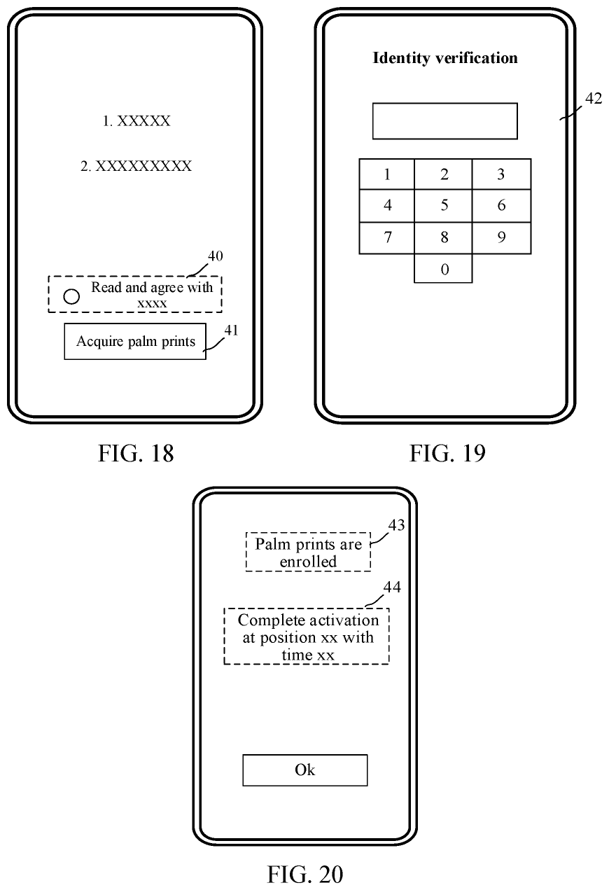

For example, as shown in FIG. 18, a first control 40 and a second control 41 are displayed. The first control 40 is configured to trigger service agreement reading, or agreement with the service agreement or rejection of the service agreement. The second control 41 is configured to trigger start of identity feature acquisition. In response to the trigger operations by the first control 40 and the second control 41, an identity feature acquisition interface is displayed.

In some embodiments, an identity verification interface is displayed in response to the trigger operations by the first control 40 and the second control 41. For example, as shown in FIG. 19, an identity verification interface 42 is displayed. The identity verification interface 42 includes a password control and/or a password display control. The password control is configured to input a password. In some embodiments, the password control is a numeric password control and/or an alphabetic password control. The password display control is configured to display the password inputted by the user.

Operation 23: The terminal turns on a camera and displays an acquisition box in first display state.

The terminal displays a real-time camera preview screen in full screen, and the terminal calculates an appropriate size of the acquisition box size according to device parameters.

In an example, the camera is turned on to display the camera preview screen and the acquisition box in the first display state, with details shown in operation 220. Operation 24: The terminal displays notification information.

For example, reference can be made to operation 420 or operation 520, or operation 620 and operation 640 for details of the notification information.

Operation 25: The terminal detects a body feature region and displays a tracking box.

A user stretches out the first body part, and is acquired by the camera. An algorithm detects the body feature region, measures an inclination angle of the first body part in real time, and displays the tracking box. The tracking box changes with movement of the first body part, and is displayed larger when closer to the first body part and smaller when farther away from the first body part. The first body part inclines, and the tracking box also inclines.

For example, details for displaying the tracking box are shown in operation 240. In some embodiments, drawing logic for the tracking box is as follows.

Assuming that a set of coordinate points representing the body feature region is obtained: (x₁, y₁), (x₂, y₂) . . . , (xₙ, yₙ).

The coordinate points are selected: a set of coordinate points representing the body feature region may be screened according to information such as a distance and an angle between a concave feature point and a convex feature point. For example, a reference feature point is selected from the feature points and is used as a center of the body feature region, and then points within a range from the center are selected as the coordinate points of the body feature region.

The coordinate points are smoothed: a smoothing algorithm, such as mean filtering, median filtering, and Gaussian filtering, may be configured to smooth the coordinate points, to reduce impact of noise. For example, a horizontal coordinate x and a vertical coordinate y of the coordinate point may be filtered separately.

An ellipse is fitted by a least square method, and parameters of the ellipse are solved. A general equation of the ellipse is as follows:

$$A {x}^{2} + B x y + C {y}^{2} + D x + E y + F = 0 ;$$

In the formula, A, B, C, D, E, and F are coefficients of any ellipse equation, and the coefficients of the ellipse equation are to be solved by using the coordinate points of the body feature regions in this disclosure. In some embodiments, in a fitting process, an error function f may be minimized:

$$f ( A , B , C , D , E , F ) = \sum {[ {Ax}_{i}^{2} + {Bx}_{i} {y}_{i} + {Cy}_{i}^{2} + {Dx}_{i} + {Ey}_{i} + F ]}^{2} ;$$

A partial derivative of f is found, and the partial derivative is let zero. By solving the ellipse equation, the parameters of the fit tracking box may be obtained.

Operation 26: The terminal responds to coincidence of the tracking box with the acquisition box in the first display state.

In some embodiments, in response to the coincidence of the tracking box and the acquisition box in the first display state, the terminal switches the acquisition box in the first display state to an acquisition box in a second display state to be displayed.

A user cooperatively moves the first body part, to align the tracking box with the acquisition box in the first display state. When aligned, the acquisition box in the second display state is displayed, indicating that the first body part reaches an optimal enrollment position. An identity feature image may be acquired.

Operation 27: The terminal obtains an image frame corresponding to the body feature region.

In some embodiments, the image frame corresponding to the body feature region is an image frame satisfying an image quality preference condition. In some embodiments, the image frame satisfying the image quality preference condition may alternatively be understood as an image frame satisfying a multi-dimensional threshold of the image. An identity feature image that satisfies the multi-dimensional threshold of the image is acquired. The multi-dimensional threshold of the image includes at least one of image quality, blur, feature information richness, or exposure.

In some embodiments, there are two types of strategies for confirmation in a case that the identity feature image is recognized to satisfy the multi-dimensional threshold of the image. In an example, the strategies are selected according to product experience requirements.

Strategy 1: the user is required to put the first body part in the acquisition box, then image quality optimization is started, and then the image is froze and uploaded if the optimization is successful. By guiding the user to put the first body part in the acquisition box, an enrollment intention of the user can be further confirmed.

Strategy 2: the user is not required to put the first body part in the acquisition box, and as long as the contour of the first body part is recognized to be complete and the image satisfies the multi-dimensional threshold of the image, enrollment can be performed. In this case, even if the first body part is not put in the acquisition box, a high or desirable quality identity feature image can be acquired.

Operation 28: The enrollment is completed.

In some embodiments, notification information of successful enrollment is displayed. For example, as shown in FIG. 20, fourth notification information 43 is displayed.

In some embodiments, fifth notification information configured to notify the user to activate a palm scanning service within a target time period is also displayed. For example, as shown in FIG. 20, the fifth notification information 44 is displayed.

Operation 29: The user performs offline palm scanning.

Operation 30: The server performs retrieval.

Operation 31: Activation succeeds.

When the user completes the online enrollment and is about to perform the palm scanning through an offline palm scanning device, the palm scanning device successfully acquires a clearer and higher-quality colorful and infrared image of the user, and gives priority to retrieval and comparison with an online enrollment library based on the identity feature in the color image. If match is found, direct use is implemented through palm scanning, and the terminal pushes a notification to notify the user to complete the activation.

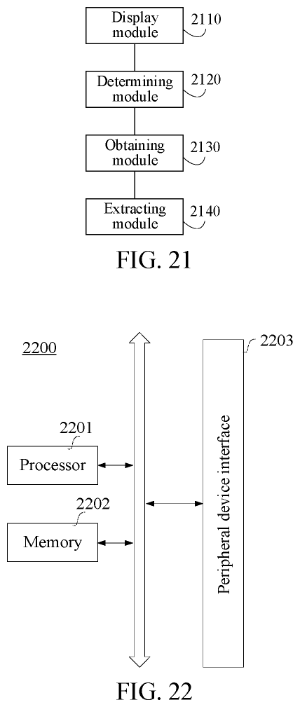

FIG. 21 shows a structural block diagram of an apparatus for determining an acquisition pose according to an aspect of this disclosure. The apparatus includes:
a display module 2110 configured to display a camera preview screen and an acquisition box in a first display state in a process of identity feature acquisition.

The display module 2110 is further configured to display, in response to determining that a body feature region is recognized in the camera preview screen, a tracking box on a screen region corresponding to the body feature region, the tracking box changing following a change in a pose of the body feature region in a real space.

The determining module 2120 is further configured to determine that the pose of the body feature region in the real space reaches the acquisition pose in response to determining that the tracking box and the acquisition box in the first display state satisfy a matching condition.

In some embodiments, the display module 2110 is further configured to take, in response to determining that the body feature region is recognized in the camera preview screen, a reference point on the screen region corresponding to the body feature region as a center point of the tracking box, and display the tracking box on the screen region.

In some embodiments, the display module 2110 is further configured to update display of the tracking box in response to at least one of inclination, translation, or rotation of the body feature region following a first body part, to keep the center point of the tracking box consistent with the reference point on the screen region corresponding to the body feature region. The first body part is a body part where the body feature region is located.

In some embodiments, the display module 2110 is further configured to take, in response to determining that the body feature region is recognized in the camera preview screen, a first size as a size of the tracking box, and display the tracking box on the screen region corresponding to the body feature region. The first size is associated with the distance between the body feature region and the camera.

In some embodiments, the first size has a negative correlation with the distance between the body feature region and the camera.

In some embodiments, the display module 2110 is further configured to take, in response to determining that the body feature region is recognized in the camera preview screen, first aspect ratio as an aspect ratio of the tracking box, and display the tracking box on the screen region corresponding to the body feature region. The first aspect ratio is associated with an included angle between a plane where the body feature region is located and a plane where a terminal screen is located.

In some embodiments, the first aspect ratio has a positive correlation with the included angle between the plane where the body feature region is located and the plane where the terminal screen is located.

In some embodiments, the matching condition includes at least one of the following:
a shape of the tracking box is the same as a shape of the acquisition box in the first display state;
the size of the tracking box is the same as a size of the acquisition box in the first display state;
a ratio of an area of the tracking box to an area of the acquisition box in the first display state is greater than or equal to a ratio threshold;
an overlapped area between the tracking box and the acquisition box in the first display state is greater than or equal to an area threshold;
a distance between a center of the tracking box and a center of the acquisition box in the first display state is less than a distance threshold;
a difference between a radius of the tracking box and a radius of the acquisition box in the first display state is less than a length difference threshold; and
an included angle between a plane where the tracking box is located and a plane where the acquisition box is located in the first display state is less than an angle difference threshold.

In some embodiments, the apparatus further includes an obtaining module 2130, the obtaining module 2130 being configured to obtain, in response to determining that a detected object is recognized in the camera preview screen, an image frame corresponding to the detected object; and
a determining module 2120 configured to extract a reference feature point from the image frame and determine the body feature region based on the reference feature point in a case that it is determined that the detected object is the first body part.

In some embodiments, the apparatus further includes an extracting module 2140. The extracting module 2140 is configured to extract a skin region from the image frame, and extract a contour of the skin region.

The determining module 2120 is further configured to determine that the detected object is the first body part in a case that the contour of the skin region corresponds to a contour of the first body part.

In some embodiments, the display module 2110 is further configured to display first notification information in a case that it is determined that the detected object is the first body part, and the contour of the skin region is incomplete, the first notification information being configured to notify adjustment of a position of the first body part.

In some embodiments, the display module 2110 is further configured to display second notification information in a case that it is determined that the detected object is not the first body part, the second notification information being configured to notify replacement of the detected object.

In some embodiments, the extracting module 2140 is further configured to extract a light feature in an image frame. The display module 2110 is further configured to display third notification information in a case that the light feature does not satisfy a light feature threshold, the third notification information being configured to notify adjustment of light of the image frame.

In some embodiments, the determining module 2120 is further configured to switch, in response to determining that the tracking box and the acquisition box in the first display state satisfy the matching condition, the acquisition box in the first display state to an acquisition box in a second display state to be displayed, the acquisition box in the second display state being configured to indicate that the pose of the body feature region in the real space reaches the acquisition pose.

The first display state is different from the second display state.

The modules, submodules, and units described in this disclosure may be implemented using processing circuitry, software, or a combination thereof. For example, the display module, determining module, obtaining module, and extracting module may be implemented as software instructions executed by processing circuitry or as dedicated hardware circuitry, or as a combination of both.

In summary, since the tracking box changes with the change in the pose of the body feature region in the real space, the user can be guided to adjust the pose of the body feature region in the real space by guiding the user to adjust the tracking box. Further, by guiding the user to adjust the tracking box to satisfy the matching condition with the acquisition box in the first display state, blind adjustment of the body feature region by the user may be reduced, and efficiency of identity feature acquisition by the user can be improved.

FIG. 22 shows a structural block diagram of a computer device 2200 according to an aspect of this disclosure. The computer device 2200 may be a portable mobile terminal, such as a smartphone, a tablet computer, an MP3 player, or an MP4 player. The computer device 2200 may alternatively be referred to as user equipment, a portable terminal, or similar. Generally, the computer device 2200 includes processing circuitry (e.g., a processor 2201) and a memory 2202.

The processor 2201 may include one or more processing cores, such as a 4-core processor and an 8-core processor. The processor 2201 may be implemented by using at least one hardware form of digital signal processing (DSP), a field programmable gate array (FPGA), and a programmable logic array (PLA). The processor 2201 may alternatively include a main processor and a co-processor. The main processor is a processor configured to process data in a wake-up state, or is referred to a central processing unit (CPU). The co-processor is a low-power processor configured to process data in a standby state. In some embodiments, a graphics processing unit (GPU) may be integrated on the processor 2201, and the GPU is configured to be responsible for rendering and drawing contents to be displayed on a display screen. In some embodiments, the processor 2201 may further include an artificial intelligence (AI) processor, and the AI processor is configured to process a computing operation related to machine learning.

The memory 2202 may include one or more computer-readable storage media, and the computer-readable storage media may be tangible and non-transitory. The memory 2202 may further include a high-speed random access memory and a nonvolatile memory, such as one or more disk storage devices or flash memory storage devices. In some embodiments, the non-transitory computer-readable storage medium in the memory 2202 is configured to store at least one instruction, and the at least one instruction is configured for being executed by the processor 2201, to implement the methods for determining an acquisition pose according to the embodiments of this disclosure.

In some embodiments, the computer device 2200 may further include a peripheral device interface 2203 and at least one peripheral devices. For example, the peripheral device includes at least one of a radio frequency circuit, a touchscreen, a camera, an audio circuit, or a power supply. Those of ordinary skill in the art can understand that a structure shown in FIG. 22 does not constitute limitation to the computer device 2200, and may include more or fewer components than components shown, or combine some components, or adopt different component arrangements.

In an example, computer devices are provided. The computer devices include a processor and a memory, the memory having at least one program stored therein, the at least one program being loaded and executed by the processor, to implement the methods for determining an acquisition pose described above.

In an example, non-transitory computer-readable storage media are provided. The non-transitory computer-readable storage media have at least one program stored therein, the at least one program, when executed by a processor, being configured to implement the methods for determining an acquisition pose described above. In some embodiments, the non-transitory computer-readable storage media may be a read-only memory (ROM), a random access memory (RAM), a compact disc read-only memory (CD-ROM), a magnetic tape, a floppy disc, or an optical data storage device.

In an example, computer program products are provided. The computer program products include at least one program, the at least one program being stored in a non-transitory computer-readable storage medium, at least one part of the program being read by a processor from the non-transitory computer-readable storage medium, and the processor executing the at least one part of program, to implement the methods for determining an acquisition pose described above.

The foregoing description provides one or more non-limiting examples of this disclosure, which shall not be construed as a limitation to the present disclosure. A person skilled in the art may make several variations and improvements without departing from the concept of this disclosure, which, however, still fall within the scope of this disclosure.

What is claimed is:

1. A method for guiding a body region toward a target pose, comprising:
displaying, on a display, a camera preview screen configured to display image frames of a camera and an acquisition box in a first display state in the camera preview screen;
determining whether the body region that corresponds to a body feature is recognized in the image frames;
displaying, based on the body region being recognized in the image frames, a tracking box corresponding to the body region in the camera preview screen, a shape of the tracking box changing with an angle between a first reference plane where the body region is located and a second reference plane corresponding to the acquisition box in a real space;
determining, by processing circuitry, that the body region reaches the target pose in the real space when the tracking box and the acquisition box in the first display state satisfy a matching condition; and
displaying, on the display, acquisition pose notification information when the body region is determined to reach the target pose in the real space.

2. The method according to claim 1, wherein the displaying the tracking box comprises:
determining, when the body region is recognized in one of the image frames, a reference point on a screen region corresponding to the body region in the one of the image frames; and
displaying the tracking box based on taking the reference point as a center point of the tracking box.

3. The method according to claim 2, further comprising:
updating display of the tracking box based on inclination, translation, or rotation of the body region, to keep the center point of the tracking box consistent with a respective reference point on a respective screen region corresponding to the body region in each of the image frames, wherein
the body region is at a body part and movable along with movement of the body part.

4. The method according to claim 1, wherein the displaying the tracking box comprises:
determining, when the body region is recognized in one of the image frames, a reference size associated with a distance between the body region and the camera; and
displaying the tracking box based on taking the reference size as a size of the tracking box.

5. The method according to claim 4, wherein the reference size has a negative correlation with the distance between the body region and the camera.

6. The method according to claim 1, wherein the displaying the tracking box comprises:
determining, when the body region is recognized in one of the image frames, a reference aspect ratio associated with the angle between the first reference plane and the second reference plane; and
displaying the tracking box based on taking the reference aspect ratio as an aspect ratio of the tracking box.

7. The method according to claim 6, wherein the reference aspect ratio has a positive correlation with the angle between the first reference plane and the second reference plane.

8. The method according to claim 1, wherein the matching condition comprises:
the shape of the tracking box is same as a shape of the acquisition box in the first display state;
a size of the tracking box is same as a size of the acquisition box in the first display state;
a ratio of an area of the tracking box to an area of the acquisition box in the first display state is greater than or equal to a ratio threshold;
an overlapped area between the tracking box and the acquisition box in the first display state is greater than or equal to an area threshold;
a distance between a center of the tracking box and a center of the acquisition box in the first display state is less than a distance threshold; or
a difference between a radius of the tracking box and a radius of the acquisition box in the first display state is less than a length difference threshold.

9. The method according to claim 1, further comprising:
extracting one or more reference feature points from one of the image frames when a detected object is recognized in the one of the image frames; and
determining the body region based on the one or more reference feature points when the detected object is recognized as a body part.

10. The method according to claim 9, further comprising:
extracting a skin region from the one of the image frames;
extracting a contour of the skin region; and
determining that the detected object is recognized as the body part when the contour of the skin region corresponds to a contour of the body part.

11. The method according to claim 10, further comprising:
displaying first notification information when the detected object is recognized as the body part, and the contour of the body part is incomplete, the first notification information indicating adjustment of a position of the body part.

12. The method according to claim 10, further comprising:
displaying second notification information when the detected object is not recognized as the body part, the second notification information indicating replacement of the detected object.

13. The method according to claim 9, further comprising:
extracting a light feature from the one of the image frames; and
displaying third notification information when the light feature does not satisfy a light feature threshold, the third notification information indicating adjustment of an illumination condition of the real space.

14. The method according to claim 1, wherein
the displaying the acquisition pose notification information comprises:
switching, when the tracking box and the acquisition box in the first display state satisfy the matching condition, display of the acquisition box in the first display state to display of an acquisition box in a second display state, the acquisition box in the second display state indicating that the body region is determined to reach the target pose in the real space, and the first display state is different from the second display state.

15. An apparatus for guiding a body region toward a target pose, comprising:
processing circuitry configured to:
display, on a display, a camera preview screen configured to display image frames of a camera and an acquisition box in a first display state in the camera preview screen;
determine whether the body region that corresponds to a body feature is recognized in the image frames;
display, based on the body region being recognized in the image frames, a tracking box corresponding to the body region in the camera preview screen, a shape of the tracking box changing with an angle between a first reference plane where the body region is located and a second reference plane corresponding to the acquisition box in a real space;
determine that the body region reaches the target pose in the real space when the tracking box and the acquisition box in the first display state satisfy a matching condition; and
display, on the display, acquisition pose notification information when the body region is determined to reach the target pose in the real space.

16. The apparatus according to claim 15, wherein the processing circuitry is configured to:
determine, when the body region is recognized in one of the image frames, a reference point on a screen region corresponding to the body region in the one of the image frames; and
display the tracking box based on taking the reference point as a center point of the tracking box.

17. The apparatus according to claim 15, wherein the processing circuitry is configured to:
determine, when the body region is recognized in one of the image frames, a reference size associated with a distance between the body region and the camera; and
display the tracking box based on taking the reference size as a size of the tracking box.

18. The apparatus according to claim 15, wherein the processing circuitry is configured to:
determine, when the body region is recognized in one of the image frames, a reference aspect ratio associated with the angle between the first reference plane and the second reference plane; and
display the tracking box based on taking the reference aspect ratio as an aspect ratio of the tracking box.

19. The apparatus according to claim 15, wherein the matching condition comprises:
the shape of the tracking box is same as a shape of the acquisition box in the first display state;
a size of the tracking box is same as a size of the acquisition box in the first display state;
a ratio of an area of the tracking box to an area of the acquisition box in the first display state is greater than or equal to a ratio threshold;
an overlapped area between the tracking box and the acquisition box in the first display state is greater than or equal to an area threshold;
a distance between a center of the tracking box and a center of the acquisition box in the first display state is less than a distance threshold; or
a difference between a radius of the tracking box and a radius of the acquisition box in the first display state is less than a length difference threshold.

20. A non-transitory computer-readable storage medium storing instructions, which when executed by a processor, cause the processor to perform a method for guiding a body region toward a target pose, the method comprising:
displaying, on a display, a camera preview screen configured to display image frames of a camera and an acquisition box in a first display state in the camera preview screen;
determining whether the body region that corresponds to a body feature is recognized in the image frames;
displaying, based on the body region being recognized in the image frames, a tracking box corresponding to the body region in the camera preview screen, a shape of the tracking box changing with an angle between a first reference plane where the body region is located and a second reference plane corresponding to the acquisition box in a real space;
determining that the body region reaches the target pose in the real space when the tracking box and the acquisition box in the first display state satisfy a matching condition; and
displaying, on the display, acquisition pose notification information when the body region is determined to reach the target pose in the real space.
